(19) United States
(12) Patent Application Publication
(10) Pub. No.: US 2026/0077343 A1
(43) Pub. Date: Mar. 19, 2026

(54) PROCESS FOR NH3 REFORMING

(71) Applicant: BASF SE, Ludwigshafen am Rhein (DE)

(72) Inventors: Elias Christopher FREI, Ludwigshafen am Rhein (DE); Matthias FELISCHAK, Ludwigshafen am Rhein (DE); Lukasz KARWACKI, Ludwigshafen am Rhein (DE); Nils BOTTKE, Ludwigshafen am Rhein (DE); Faruk OEZKIRIM, Ludwigshafen am Rhein (DE)

(21) Appl. No.: 19/110,136

(22) PCT Filed: Sep. 11, 2023
(86) PCT No.: PCT/EP2023/074906

§ 371 Date: Mar. 10, 2025

(30) Foreign Application Priority Data
Sep. 12, 2022 (EP) 22195128.8
Jul. 24, 2023 (EP) 23187282.1

(51) Int. Cl. B01J 37/18; B01J 23/755; C01B 3/04

(52) U.S. Cl. CPC B01J 37/18; B01J 23/755; C01B 3/047

(57) ABSTRACT

The present invention relates to a process for NH₃ reforming, the process comprising (i) providing a reactor containing an NH₃-reforming catalyst C1 comprising a metal M1 selected from the group consisting of groups 6 to 11 of the periodic table, including mixtures of two or more thereof; (ii) preparing a feed gas stream F1 containing NH₃; (iii) feeding F1 into the reactor and contacting F1 with C1, wherein the reactor has a temperature of 100° C. or more; obtaining a product gas stream P1 comprising H₂O, and an NH₃-reforming catalyst C2; wherein feeding according to (ii) is started at a point in time t1; wherein at a point in time t2 the H₂O(P1):H₂O(F1) molar ratio of H₂O in P1 to H₂O in F1 is greater than 1:1, wherein the difference between t2 and t1 is in the range of from 5 s to 10 days.

### TECHNICAL FIELD

The present invention relates to a process for NH₃ reforming using an NH₃-reforming catalyst, the process comprising a step for reducing said catalyst in a gas stream comprising NH₃.

### INTRODUCTION

NH₃ is seen as an energy vector of the future, able to store chemically significant amounts of H₂. So, sustainable NH₃ might be produced on a large scale from regenerative energy sources. The reforming of NH₃ (see equation 1 below) on site, where the H₂ is needed, might be the last step in closing an H₂ value chain based on renewable electricity.

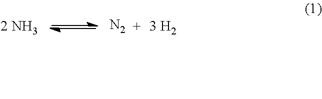

In order to have direct access to H₂ at elevated pressure, in particular at a pressure in the range of 10 to 50 bara, the NH₃-reforming itself is also very often conducted at these pressures.
I. Lucentini et al., Ind. Eng. Chem. Res. 2021, 60, 18560-18611 as well as T. Le et al., Korean J. Chem. Eng., 2021, 38(6), 1087-1103 respectively provide an overview of catalysts which are employed in the decomposition of ammonia.
X.-K. Li et al., Journal of Catalysis, 2005, 236, 181-189 specifically relates to the decomposition of ammonia over Ni and Ru catalysts.
Bell et al., Top Catal., 2016, 59, 1438-1457 concerns the decomposition of ammonia employing non-noble metal catalysts, wherein mainly Co- and Ni-containing catalysts are discussed.
Fang et al. in ACS Catalysis 2022, 12, 3938-3954 give an overview on challenges and opportunities of Ru-based catalysts toward the synthesis and utilization of ammonia.

Typically used NH₃ reforming catalysts have to be activated in a reduction gas prior to NH₃ reforming. Conventionally, an NH₃-reforming catalyst is activated with hydrogen as reducing agent, which can be diluted with an inert gas, for example with one or more of N₂ or Ar. WO 2023/111017 A1 for example relates to a process for the reforming of ammonia, specifically allowing reforming at comparatively high pressures, which involves the activation of the catalyst with H₂.

Thus, there was a need to provide a comparatively more facile process, in particular by avoiding an additional step of preparing a specific reduction stream for reducing the used catalyst.

### DETAILED DESCRIPTION

It was therefore the object of the present invention to provide a process for NH₃ reforming allowing a facile and resource efficient process. Surprisingly, it has been found that a novel process for NH₃ reforming can be provided, wherein the used NH₃-reforming catalyst is reduced in a gas stream comprising NH₃. Thus, it was found that by applying the NH₃ feedstock as activation reactant the starting sequence or even an NH₃ reforming plant can be facilitated. The process of the present invention is generally applicable for any NH₃ reforming catalyst, which has to be activated in a reduction gas.

Therefore, the present invention relates to a process for NH₃ reforming, the process comprising
(i) providing a reactor containing an NH₃-reforming catalyst C1 comprising a metal M1 selected from the group consisting of groups 6 to 11 of the periodic table, including mixtures of two or more thereof;
(ii) preparing a feed gas stream F1 containing NH₃;
(iii) feeding F1 prepared according to (ii) into the reactor and contacting F1 with the NH₃-reforming catalyst C1, wherein the reactor has a temperature of 100° C. or more;
obtaining a product gas stream P1 comprising H₂O, and an NH₃-reforming catalyst C2;
wherein feeding according to (ii) is started at a point in time t1;
wherein at a point in time t2 the H₂O(P1):H₂O(F1) molar ratio of H₂O in the product gas stream P1 to H₂O in the feed gas stream F1 is greater than 1:1, wherein the H₂O in the product gas stream P1 and the H₂O in the feed gas stream F1 are preferably determined according to DIN EN 14790, more preferably according to Reference Example 1, wherein the difference between t2 and t1 is in the range of from 5 s to 10 days.

In the context of the present invention, the difference between t2 and t1 can also be designated as Δt. Further, the difference Δt between t2 and t1 is calculated as Δt=t2−t1, wherein t2 is greater than t1.

It is preferred that at a point in time t2 the H₂O(P1):H₂O(F1) molar ratio of H₂O in the product gas stream P1 to H₂O in the feed gas stream F1 is in the range of from 1.0001:1 to 25:1, more preferably in the range of from 1.0005:1 to 15:1, more preferably in the range of from 1.001:1 to 10:1, more preferably in the range of from 1.005:1 to 5:1, more preferably in the range of from 1.01:1 to 4:1, more preferably in the range of from 1.05:1 to 3:1, more preferably in the range of from 1.1:1 to 2:1.

It is preferred that the difference between t2 and t1 is in the range of from 5 s to 9 d, preferably in the range of from 1 min to 8 d, more preferably in the range of from 5 min to 7 d, more preferably in the range of from 0.5 h to 5 d, more preferably in the range of from 1 h to 4 d, more preferably in the range of from 3 h to 2 d, more preferably in the range of from 6 h to 2 d.

It is preferred that the X-ray diffractogram of the NH₃-reforming catalyst C1 contained in the reactor provided in (i) displays one or more crystalline phases of one or more oxides of M1, preferably determined according to Reference Example 2.

It is preferred that the X-ray diffractogram of the NH₃-reforming catalyst C2 obtained from (iii) displays one or more crystalline phases of elemental M1, preferably determined according to Reference Example 2.

It is preferred that the X-ray diffractogram of the NH₃-reforming catalyst C2 obtained from (iii) does not display any crystalline phases of one or more oxides of M1, preferably determined according to Reference Example 2.

It is preferred that M1 is selected from the group consisting of Ru, Ni, Rh, Co, Ir, Fe, Pt, Cr, Pd, Cu, and mixtures of two or more thereof, more preferably from the group consisting of Ni, Co, Ru, Fe and a mixture thereof.

In the case wherein M1 is selected from the group consisting of Ru, Ni, Rh, Co, Ir, Fe, Pt, Cr, Pd, Cu, and mixtures of two or more thereof, it is preferred that M1 comprises, preferably is, Ni.

In the case wherein M1 comprises Ni, it is preferred that the XRD pattern of the NH₃-reforming catalyst C1 contained in the reactor provided in (i) displays a weight ratio of a NiO crystalline phase to an elemental Ni crystalline phase of greater than 1:100, more preferably of greater than 1:10, more preferably in the range of from 1:10 to 100:1, more preferably in the range of from 1:10 to 10:1, wherein the XRD pattern is preferably determined according to Reference Example 2.

Further in the case wherein M1 comprises Ni, it is preferred that the TPR profile of the NH₃-reforming catalyst C1 contained in the reactor provided in (i) displays a first peak having a maximum in the range of from 100 to 400° C., more preferably in the range of from 120 to 350° C., more preferably in the range of from 150 to 250° C., wherein the TPR profile is preferably determined according to Reference Example 3.

In the case wherein the TPR profile of the NH₃-reforming catalyst C1 contained in the reactor provided in (i) displays a first peak having a maximum in the range of from 100 to 400° C., it is preferred that the integration of the first peak affords a value in the range of from 500 to 4000 μmol/g, more preferably in the range of from 1500 to 3000 μmol/g, more preferably in the range of from 2000 to 2500 μmol/g.

Further in the case wherein the TPR profile of the NH₃-reforming catalyst C1 contained in the reactor provided in (i) displays a first peak having a maximum in the range of from 100 to 400° C., it is preferred that the TPR profile of the NH₃-reforming catalyst C1 contained in the reactor provided in (i) displays a second peak having a maximum in the range of from greater than 400 to 900° C., more preferably in the range of from 425 to 850° C., more preferably in the range of from 450 to 800° C., wherein the TPR profile is preferably determined according to Reference Example 3.

In the case wherein the TPR profile of the NH₃-reforming catalyst C1 contained in the reactor provided in (i) displays a second peak having a maximum in the range of from greater than 400 to 900° C., it is preferred that the integration of the second peak affords a value in the range of from 500 to 4500 μmol/g, more preferably in the range of from 1500 to 3500 μmol/g, more preferably in the range of from 2000 to 3000 μmol/g.

Further in the case wherein the TPR profile of the NH₃-reforming catalyst C1 contained in the reactor provided in (i) displays a first peak having a maximum in the range of from 100 to 400° C., it is preferred that the TPR profile of the NH₃-reforming catalyst C1 contained in the reactor provided in (i) displays a third peak having a maximum in the range of from greater than 900 to 1300° C., preferably in the range of from 950 to 1250° C., more preferably in the range of from 1000 to 1200° C., wherein the TPR profile is preferably determined according to Reference Example 3.

In the case wherein the TPR profile of the NH₃-reforming catalyst C1 contained in the reactor provided in (i) displays a third peak having a maximum in the range of from greater than 900 to 1300° C., it is preferred that the integration of the third peak affords a value in the range of from 100 to 1500 μmol/g, more preferably in the range of from 300 to 1250 μmol/g, more preferably in the range of from 500 to 1000 μmol/g.

In the case wherein M1 is selected from the group consisting of Ru, Ni, Rh, Co, Ir, Fe, Pt, Cr, Pd, Cu, and mixtures of two or more thereof, it is preferred that M1 comprises, more preferably is, Ru.

In the case wherein M1 comprises, more preferably is, Ru, it is preferred that the TPR profile of the NH₃-reforming catalyst C1 contained in the reactor provided in (i) displays a peak having a maximum in the range of from 100 to 400° C., more preferably in the range of from 120 to 350° C., more preferably in the range of from 150 to 250° C., wherein the TPR profile is preferably determined according to Reference Example 3.

In the case wherein the TPR profile of the NH₃-reforming catalyst C1 contained in the reactor provided in (i) displays a peak having a maximum in the range of from 100 to 400° C., it is preferred that the integration of the peak affords a value in the range of from 1500 to 5000 μmol/g, more preferably in the range of from 2500 to 4000 μmol/g, more preferably in the range of from 3000 to 3500 μmol/g.

It is preferred that the reactor provided in (i) has a length in the range of from 0.5 to 20 m, more preferably in the range of from 1 to 12 m.

It is preferred that the reactor provided in (i) is operated in adiabatic mode.

It is preferred that the reactor provided in (i) is directly heated, preferably flame-heated or electrically heated.

It is preferred that the feed gas stream F1 prepared according to (ii) comprises from 0 to 0.5 volume-%, more preferably from 0 to 0.2 volume-%, more preferably from 0 to 0.1 volume-%, more preferably from 0 to 0.05 volume-%, more preferably from 0 to 0.02 volume-%, more preferably from 0 to 0.01 volume-%, more preferably from 0 to 0.005 volume-%, more preferably from 0 to 0.002 volume-%, more preferably from 0 to 0.001 volume-%, of H₂.

It is preferred that the feed gas stream F1 prepared according to (ii) comprises from 1 to 100 volume-%, more preferably from 2 to 100 volume-%, more preferably from 4 to 100 volume-%, more preferably from 5 to 100 volume-%, more preferably from 50 to 100 volume-%, more preferably from 80 to 100 volume-%, more preferably from 85 to 100 volume-%, more preferably from 89.5 to 100 volume-%, preferably from 94.5 to 100 volume-%, more preferably from 99.0 to 100 volume-%, more preferably from 99.5 to 100 volume-%, more preferably from 99.6 to 100 volume-%, more preferably from 99.7 to 100 volume-%, more preferably from 99.8 to 100 volume-%, more preferably from 99.9 to 100 volume-%, more preferably from 99.95 to 100 volume-%, more preferably from 99.98 to 100 volume-%, more preferably from 99.99 to 100 volume-%, of NH₃.

It is preferred that the feed gas stream F1 prepared according to (ii) has an NH₃ partial pressure in the range of from 0.01 to 65 bara, more preferably in the range of from 0.05 to 45 bara, more preferably in the range of from 0.1 to 25 bara, more preferably in the range of from 0.5 to 15 bara, more preferably in the range of from 1 to 10 bara.

It is preferred that the feed gas stream F1 prepared according to (ii) comprises from 0 to 1 volume-%, more preferably from 0 to 0.8 volume-%, more preferably from 0.0001 to 0.7 volume-%, more preferably from 0.0001 to 0.6 volume-%, more preferably from 0.03 to 0.5 volume-%, more preferably from 0.05 to 0.4 volume-%, of H₂O.

It is preferred that the feed gas stream F1 prepared according to (ii) comprises from 0 to 99 volume-%, more preferably from 98 volume-%, more preferably from 0 to 96 volume-%, more preferably from 0 to 95 volume-%, more preferably from 0 to 50 volume-%, more preferably from 0 to 30 volume-%, more preferably from 0 to 20 volume-%, more preferably from 0 to 10 volume-%, more preferably from 0 to 5 volume-%, of an inert gas, wherein the inert gas comprises, preferably consists of, one or more of Ar and N₂, preferably N₂.

It is preferred that from 99 to 100 volume-%, preferably from 99.9 to 100 volume-%, more preferably from 99.99 to 100 volume-%, of the feed gas stream F1 prepared according to (ii) consists of NH₃, H₂, optionally H₂O, and optionally an inert gas, wherein the inert gas comprises, preferably consists of, one or more of Ar and N, preferably N₂.

It is preferred that the feed gas stream F1 prepared according to (ii) is fed into the reactor according to (iii) having a gas hourly space velocity in the range of from 100 to 15,000 h⁻¹, more preferably in the range of from 500 to 10,000 h⁻¹, more preferably in the range of from 1000 to 5000 h⁻¹, more preferably in the range of from 2000 to 4750 h⁻¹, more preferably in the range of from 3500 to 4500 h⁻¹.

It is preferred that contacting according to (iii) is performed at a pressure in the range of from 1 to 65 bara, more preferably of from 2 to 50 bara, more preferably of from 4 to 35 bara, more preferably of from 5 to 10 bara.

It is preferred that contacting according to (iii) is performed at a temperature in the range of from 200 to 1000° C., more preferably of from 350 to 800° C., more preferably of from 450 to 650° C.

It is preferred that the process further comprises
(iv) preparing a feed gas stream F2 comprising NH₃;
(v) feeding the feed gas stream F2 prepared according to (iv) into the reactor and contacting the feed gas stream F2 with the NH₃-reforming catalyst C2 obtained from (iii);
(vi) removing an effluent gas stream from the reactor, the effluent gas stream comprising H₂ and N₂.

In the case wherein the process further comprises (iv), (v) and (vi), it is preferred that the feed gas stream F2 prepared according to (iv) comprises from 0 to 0.5 volume-%, more preferably from 0 to 0.2 volume-%, more preferably from 0 to 0.1 volume-%, more preferably from 0 to 0.05 volume-%, more preferably from 0 to 0.02 volume-%, more preferably from 0 to 0.01 volume-%, more preferably from 0 to 0.005 volume-%, more preferably from 0 to 0.002 volume-%, more preferably from 0 to 0.001 volume-%, of H₂.

Further in the case wherein the process further comprises (iv), (v) and (vi), it is preferred that the feed gas stream F2 prepared according to (iv) comprises from 1 to 100 volume-%, more preferably from 2 to 100 volume-%, more preferably from 4 to 100 volume-%, more preferably from 5 to 100 volume-%, more preferably from 50 to 100 volume-%, more preferably from 80 to 100 volume-%, more preferably from 85 to 100 volume-%, more preferably from 89.5 to 100 volume-%, preferably from 94.5 to 100 volume-%, more preferably from 99.0 to 100 volume-%, more preferably from 99.5 to 100 volume-%, more preferably from 99.6 to 100 volume-%, more preferably from 99.7 to 100 volume-%, of NH₃.

Further in the case wherein the process further comprises (iv), (v) and (vi), it is preferred that the feed gas stream F2 prepared according to (iv) comprises from 0 to 1 volume-%, more preferably from 0 to 0.8 volume-%, more preferably from 0.0001 to 0.7 volume-%, more preferably from 0.0001 to 0.5 volume-%, more preferably from 0.0005 to 0.4 volume-%, more preferably from 0.001 to 0.3, of H₂O.

Further in the case wherein the process further comprises (iv), (v) and (vi), it is preferred that the feed gas stream F2 prepared according to (iv) comprises from 0 to 99 volume-%, more preferably from 98 volume-%, more preferably from 0 to 96 volume-%, more preferably from 0 to 95 volume-%, more preferably from 0 to 50 volume-%, more preferably from 0 to 30 volume-%, more preferably from 0 to 20 volume-%, more preferably from 0 to 10 volume-%, more preferably from 0 to 5 volume-%, of an inert gas, wherein the inert gas comprises, preferably consists of, one or more of Ar and N₂, preferably N₂.

Further in the case wherein the process further comprises (iv), (v) and (vi), it is preferred that from 99 to 100 volume-%, more preferably from 99.9 to 100 volume-%, more preferably from 99.99 to 100 volume-%, of the feed gas stream F2 prepared according to (iv) consists of NH₃, H₂, optionally H₂O, and optionally an inert gas, wherein the inert gas comprises, preferably consists of, one or more of Ar and N₂, preferably N₂.

Further in the case wherein the process further comprises (iv), (v) and (vi), it is preferred that the feed gas stream F2 prepared according to (iv) has the same chemical composition as the feed gas stream F1 prepared according to (ii).

Further in the case wherein the process further comprises (iv), (v) and (vi), it is preferred that the feed gas stream F2 prepared according to (iv) is fed into the reactor according to (v) having a gas hourly space velocity in the range of from 500 to 15,000 h⁻¹, more preferably in the range of from 1000 to 10,000 h⁻¹, more preferably in the range of from 2000 to 8000 h⁻¹, more preferably in the range of from 3250 to 6000 h⁻¹, more preferably in the range of from 3500 to 5000 h⁻¹.

Further in the case wherein the process further comprises (iv), (v) and (vi), it is preferred that contacting according to (v) is performed at a pressure in the range of from 10 to 65 bara, preferably of from 20 to 55 bara, more preferably of from 30 to 50 bara, more preferably of from 35 to 45 bara.

Further in the case wherein the process further comprises (iv), (v) and (vi), it is preferred that contacting according to (v) is performed at a temperature in the range of from 200 to 950° C., preferably of from 250 to 800° C., more preferably of from 300 to 700° C., more preferably of from 325 to 600° C., more preferably of from 350 to 550° C.

Further in the case wherein the process further comprises (iv), (v) and (vi), it is preferred that the NH₃-reforming catalyst C1 contained in the reactor provided in (i) further comprises a metal M2 selected from the group consisting of alkali metals, alkaline earth metals, Mo, Fe, Ru, and mixtures of two or more thereof, more preferably from the group consisting of Li, K, Na, Cs, Mg, Ca, Sr, Ba, Mo, Fe, Ru, and mixtures of two or more thereof, more preferably from the group consisting of K, Na, Cs, Ba, Mo, Fe, Ru, and mixtures of two or more thereof, more preferably from the group consisting of K, Ba, Mo, Fe, Ru, and mixtures of two or more thereof, more preferably from the group consisting of Fe, Ru, and a mixture thereof, wherein M2 more preferably is Ru.

In the case wherein the NH₃-reforming catalyst C1 contained in the reactor provided in (i) further comprises a metal M2 selected from the group consisting of alkali metals, alkaline earth metals, Mo, Fe, Ru, and mixtures of two or more thereof, it is preferred that the NH₃-reforming catalyst C1 contained in the reactor provided in (i) further comprises one or more support materials onto which one or more of M1 and M2, preferably M1 and M2, are supported, wherein the one or more support materials are preferably selected from the group consisting of Al₂O₃, SiO₂, ZrO₂, CeO₂, MgO, CaO, and mixtures of two or more thereof, more preferably from the group consisting of Al₂O₃, SiO₂, ZrO₂, CeO₂, and mixtures of two or more thereof, more preferably from the group consisting of Al₂O₃, SiO₂, and mixtures thereof, wherein more preferably the support material comprises Al₂O₃.

Further in the case wherein the NH₃-reforming catalyst C1 contained in the reactor provided in (i) further comprises a metal M2 selected from the group consisting of alkali metals, alkaline earth metals, Mo, Fe, Ru, and mixtures of two or more thereof, it is preferred that the NH₃-reforming catalyst C1 contained in the reactor provided in (i) further displays an M2:M1 atomic ratio in the range of from 0.1:99.9 to 80:20, preferably of from 0.5:99.5 to 75:25, more preferably of from 1:99 to 70:30, more preferably of from 5:95 to 65:35, more preferably of from 15:85 to 60:40, more preferably of from 30:70 to 55:45, and more preferably of from 40:60 to 50:50.

Further in the case wherein the NH₃-reforming catalyst C1 contained in the reactor provided in (i) further comprises a metal M2 selected from the group consisting of alkali metals, alkaline earth metals, Mo, Fe, Ru, and mixtures of two or more thereof, it is preferred that M2 comprises, preferably is, Fe or Co, and wherein the NH₃-reforming catalyst C1 contained in the reactor provided in (i) displays an M2:M1 atomic ratio in the range of from 1:99 to 80:20, more preferably of from 5:95 to 75:25, more preferably of from 10:90 to 70:30, more preferably of from 20:80 to 65:35, more preferably of from 30:70 to 60:40, more preferably of from 35:65 to 55:45, and more preferably of from 40:60 to 50:50.

Further in the case wherein the NH₃-reforming catalyst C1 contained in the reactor provided in (i) further comprises a metal M2 selected from the group consisting of alkali metals, alkaline earth metals, Mo, Fe, Ru, and mixtures of two or more thereof, it is preferred that M2 comprises, preferably is, Ru, and wherein the NH₃-reforming catalyst C1 contained in the reactor provided in (i) displays an M2:M1 atomic ratio in the range of from 0.1:99.9 to 30:70, more preferably of from 0.5:99.5 to 30:70, more preferably of from 1:99 to 20:80, more preferably of from 3:97 to 10:90, and more preferably of from 5:95 to 6:94.

According to a first alternative, and further in the case wherein the NH₃-reforming catalyst C1 contained in the reactor provided in (i) further comprises a metal M2 selected from the group consisting of alkali metals, alkaline earth metals, Mo, Fe, Ru, and mixtures of two or more thereof, it is preferred that the NH₃-reforming catalyst C1 contained in the reactor provided in (i) further comprises Al and O.

In the case wherein the the NH₃-reforming catalyst C1 contained in the reactor provided in (i) further comprises Al and O, it is preferred that the NH₃-reforming catalyst C1 contained in the reactor provided in (i) comprises Ni as the metal M1, wherein more preferably the metal M1 is Ni.

In the case wherein the NH₃-reforming catalyst C1 contained in the reactor provided in (i) comprises Ni as the metal M1, wherein more preferably the metal M1 is Ni, it is preferred that the NH₃-reforming catalyst C1 contained in the reactor provided in (i) further comprises Mg, wherein the Ni:Mg:Al molar ratio is more preferably in the range of from 1:(0.1-12):(0.5-20), more preferably of from 1:(0.5-8):(1-12), more preferably of from 1:(1-5):(3-8), more preferably of from 1:(1.5-3):(3.5-5), and more preferably of from 1:(2.0-2.4):(4.0-4.4).

Further in the case wherein the NH₃-reforming catalyst C1 contained in the reactor provided in (i) comprises Ni as the metal M1, wherein more preferably the metal M1 is Ni, it is preferred according to one alternative that from 95 to 100 wt.-% of the NH₃-reforming catalyst C1 contained in the reactor provided in (i) consists of Ni, Mg, Al, and O, more preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.

Further in the case wherein the NH₃-reforming catalyst C1 contained in the reactor provided in (i) comprises Ni as the metal M1, wherein more preferably the metal M1 is Ni, it is preferred according to a further alternative that from 95 to 100 wt.-% of the NH₃-reforming catalyst C1 contained in the reactor provided in (i) consists of M2, Ni, Mg, Al, and O, more preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.

According to a second alternative, and further in the case wherein the NH₃-reforming catalyst C1 contained in the reactor provided in (i) further comprises a metal M2 selected from the group consisting of alkali metals, alkaline earth metals, Mo, Fe, Ru, and mixtures of two or more thereof, it is preferred that the NH₃-reforming catalyst C1 contained in the reactor provided in (i) comprises Co as the metal M1, wherein more preferably the metal M1 is Co.

In the case wherein the NH₃-reforming catalyst C1 contained in the reactor provided in (i) comprises Co as the metal M1, wherein more preferably the metal M1 is Co, it is preferred that the NH₃-reforming catalyst C1 contained in the reactor provided in (i) further comprises La, wherein the Co:La:Al molar ratio is more preferably in the range of from 1:(0.1-8):(1-50), more preferably of from 1:(0.5-5):(3-30), more preferably of from 1:(0.8-3):(5-20), more preferably of from 1:(1-2):(8-15), and more preferably of from 1:(1.3-1.7):(10-12).

Further in the case wherein the NH₃-reforming catalyst C1 contained in the reactor provided in (i) comprises Co as the metal M1, wherein more preferably the metal M1 is Co, it is preferred according to one alternative that from 95 to 100 wt.-% of the NH₃-reforming catalyst C1 contained in the reactor provided in (i) consists of Co, La, Al, and O, more preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.

Further in the case wherein the NH₃-reforming catalyst C1 contained in the reactor provided in (i) comprises Co as the metal M1, wherein more preferably the metal M1 is Co, it is preferred according to a further alternative that from 95 to 100 wt.-% of the NH₃-reforming catalyst C1 contained in the reactor provided in (i) consists of M2, Co, La, Al, and O, more preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.

It is preferred that the NH₃-reforming catalyst C1 contained in the reactor provided in (i) is in form of a molding.

In the case wherein the NH₃-reforming catalyst C1 contained in the reactor provided in (i) is in form of a molding, it is preferred that the molding is a tablet.

According to a first alternative, and in the case wherein the molding is a tablet, it is preferred that the tablet has a four-hole cross-section, more preferably a four-hole cross-section having a diameter in the range of from 5 to 19 mm, more preferably in the range of from 8 to 18 mm, more preferably in the range of from 16.7 to 16.8 mm, and a height in the range of from 7 to 11 mm, preferably in the range of from 9.5 to 10.5 mm, more preferably in the range of from 9.7 to 10.0 mm.

In the case wherein the tablet has a four-hole cross-section, more preferably a four-hole cross-section having a diameter in the range of from 5 to 19 mm, it is preferred that the tablet is a calcined tablet, wherein the calcination has more preferably been performed in a gas atmosphere having a temperature in the range of from 350 to 450° C., more preferably in the range of from 360 to 440° C., more preferably in the range of from 375 to 425° C., more preferably in the range of from 390 to 410° C., wherein the gas atmosphere more preferably comprised oxygen, more preferably was one or more of oxygen, air, or lean air, wherein the calcining was performed more preferably for 0.5 to 20, more preferably for 1 to 15 h, more preferably for 2 to 10 h, more preferably for 3 to 5 h.

Further in the case wherein the tablet has a four-hole cross-section, it is preferred that the tablet has a side crushing strength 1 (SCS1) of at least 70 N, more preferably in the range of from 70 to 250 N, more preferably in the range of from 70 to 130 N, determined as described in Reference Example 5, wherein four cylindrical segments are located in an area each between two flutes, wherein the side crushing strength 1 is measured according to Reference Example 5 in a condition where the tablet stands on two cylindrical segments sided by a flute.

Further in the case wherein the tablet has a four-hole cross-section, it is preferred that the tablet has a side crushing strength 2 (SCS2) of at least 60 N, more preferably in the range of from 60 to 200 N, more preferably in the range of from 60 to 88 N, determined as described in Reference Example 5, wherein four cylindrical segments are located in an area each between two flutes, wherein the side crushing strength 2 is measured according to Reference Example 5 in a condition where the tablet stands on a cylindrical segment.

Further in the case wherein the tablet has a four-hole cross-section, it is preferred that the tablet has a side crushing strength 3 (SCS3) of at least 190 N, more preferably in the range of from 190 to 350 N, more preferably in the range of from 190 to 240 N, determined as described in Reference Example 5, wherein four cylindrical segments are located in an area each between two flutes, wherein the side crushing strength 3 is measured according to Reference Example 5 in a condition where the area of the cylindrical segments is perpendicular to the direction of the force applied on the tablet.

According to a second alternative, and in the case wherein the molding is a tablet, it is preferred that the tablet has a four-hole cross-section, more preferably a four-hole cross-section having a diameter in the range of from 10 to 18 mm, more preferably in the range of from 13.5 to 16.0 mm, more preferably in the range of from 14.0 to 15.5 mm, and a height in the range of from 5 to 11 mm, more preferably in the range of from 7.5 to 9.4 mm, more preferably in the range of from 8.2 to 9.0 mm.

In the case wherein the tablet has a four-hole cross-section, more preferably a four-hole cross-section having a diameter in the range of from 10 to 18 mm, it is preferred that the tablet is a calcined tablet, wherein the calcination has preferably been performed in a gas atmosphere having a temperature in the range of from 800 to 1400° C., more preferably in the range of from 875 to 1275° C., more preferably in the range of from 950 to 1250° C., more preferably in the range of from 1050 to 1225° C., wherein the gas atmosphere more preferably comprised oxygen, more preferably was one or more of oxygen, air, or lean air, wherein the calcining was performed more preferably for 0.5 to 20 h, more preferably for 1 to 15 h, more preferably for 2 to 10 h, more preferably for 3 to 5 h.

Further in the case wherein the tablet has a four-hole cross-section, more preferably a four-hole cross-section having a diameter in the range of from 10 to 18 mm, it is preferred that the tablet has a side crushing strength 1 (SCS1) of at least 366 N, more preferably of at least 400 N, more preferably in the range of from 400 to 800 N, more preferably in the range of from 400 to 600 N, more preferably in the range of from 400 to 570 N, determined as described in Reference Example 4, the molding more preferably being a tablet having a four-hole cross-section and having four flutes, wherein four cylindrical segments are located in an area each between two flutes, wherein the side crushing strength 1 is measured according to Reference Example 4 in a condition where the tablet stands on two cylindrical segments sided by a flute.

Further in the case wherein the tablet has a four-hole cross-section, more preferably a four-hole cross-section having a diameter in the range of from 10 to 18 mm, it is preferred that the tablet has a side crushing strength 2 (SCS2) of at least 170 N, more preferably of at least 190 N, more preferably in the range of from 190 to 450 N, more preferably in the range of from 190 to 300 N, more preferably in the range of from 190 to 270 N, determined as described in Reference Example 4, wherein four cylindrical segments are located in an area each between two flutes, wherein the side crushing strength 2 is measured according to Reference Example 4 in a condition where the tablet stands on a cylindrical segment.

Further in the case wherein the tablet has a four-hole cross-section, more preferably a four-hole cross-section having a diameter in the range of from 10 to 18 mm, it is preferred that the tablet has a side crushing strength 3 (SCS3) of at least 345 N, more preferably of at least 500 N, more preferably in the range of from 500 to 950 N, more preferably in the range of from 500 to 800 N, more preferably in the range of from 500 to 770 N, determined as described in Reference Example 4, wherein four cylindrical segments are located in an area each between two flutes, wherein the side crushing strength 3 is preferably measured according to Reference Example 4 in a condition where the area of the cylindrical segments is perpendicular to the direction of the force applied on the tablet.

In accordance with the above, in particular with the particular and preferred embodiment relating to cases wherein the NH₃-reforming catalyst C1 contained in the reactor provided in (i) comprises Ru, it is preferred that the NH₃-reforming catalyst C1 contained in the reactor provided in (i) further comprises one or more support materials, wherein Ru is supported on the one or more support materials.

In the case wherein the NH₃-reforming catalyst C1 contained in the reactor provided in (i) comprises Ru and one or more support materials, wherein Ru is supported on the one or more support materials, it is preferred that the NH₃-reforming catalyst C1 contained in the reactor provided in (i) comprises 1 wt.-% or less, more preferably 0.5 wt.-%, more preferably 0.1 wt.-% or less, more preferably 0.05 wt.-% or less, more preferably 0.01 wt.-% or less, more preferably 0.005 wt.-% or less, and more preferably 0.001 wt.-% or less, of Ni and Co calculated as the respective element and based on 100 wt.-% of the NH₃-reforming catalyst C1.

Further in the case wherein the NH₃-reforming catalyst C1 contained in the reactor provided in (i) comprises Ru and one or more support materials, wherein Ru is supported on the one or more support materials, it is preferred according to one alternative that the one or more support materials display a BET surface area of 20 m²/g or more, more preferably in the range of from 30 to 800 m²/g, more preferably of from 40 to 500 m²/g, more preferably of from 50 to 300 m²/g, more preferably of from 60 to 200 m²/g, more preferably of from 70 to 100 m²/g, and more preferably of from 75 to 80 m²/g, wherein the BET surface area is preferably determined according to ISO 9277:2010.

Further in the case wherein the NH₃-reforming catalyst C1 contained in the reactor provided in (i) comprises Ru and one or more support materials, wherein Ru is supported on the one or more support materials, it is preferred according to a further alternative that the one or more support materials display a BET surface area of 20 m²/g or more, more preferably in the range of from greater than 20 to 150 m²/g, more preferably of from 21 to 100 m²/g, more preferably of from 22 to 70 m²/g, more preferably of from 23 to 50 m²/g, more preferably of from 24 to 40 m²/g, and more preferably of from 25 to 35 m²/g, wherein the BET surface area is preferably determined according to ISO 9277:2010.

Further in the case wherein the NH₃-reforming catalyst C1 contained in the reactor provided in (i) comprises Ru and one or more support materials, wherein Ru is supported on the one or more support materials, it is preferred that the one or more support materials display a pore volume in the range of from 0.2 to 3 ml/g, more preferably of from 0.4 to 1.5 ml/g, more preferably of from 0.6 to 1 ml/g, and more preferably of from 0.8 to 0.85 ml/g, wherein the pore volume is preferably determined according to ISO 15901-2:2022.

Further in the case wherein the NH₃-reforming catalyst C1 contained in the reactor provided in (i) comprises Ru and one or more support materials, wherein Ru is supported on the one or more support materials, it is preferred that the NH₃ reforming catalyst C1 contained in the reactor provided in (i) displays a BET surface area in the range of 20 to 800 m²/g, more preferably of from 30 to 500 m²/g, more preferably of from 40 to 300 m²/g, more preferably of from 50 to 200 m²/g, more preferably of from 60 to 100 m²/g, and more preferably of from 70 to 75 m²/g, wherein the BET surface area is preferably determined according to ISO 9277:2010.

Further in the case wherein the NH₃-reforming catalyst C1 contained in the reactor provided in (i) comprises Ru and one or more support materials, wherein Ru is supported on the one or more support materials, it is preferred that the NH₃ reforming catalyst C1 contained in the reactor provided in (i) displays a pore volume in the range of 0.1 to 2 ml/g, more preferably of from 0.15 to 1.2 ml/g, more preferably of from 0.2 to 0.8 ml/g, more preferably of from 0.25 to 0.5 ml/g, and more preferably of from 0.3 to 0.35 ml/g, wherein the pore volume is preferably determined according to ISO 15901-2:2022.

Further in the case wherein the NH₃-reforming catalyst C1 contained in the reactor provided in (i) comprises Ru and one or more support materials, wherein Ru is supported on the one or more support materials, it is preferred that from 90 to 100 wt.-% of Ru calculated as the element, and based on 100 wt.-% of Ru contained in the NH₃ reforming catalyst C1 contained in the reactor provided in (i), is supported on the one or more support materials comprised in the catalyst, more preferably of from 95 to 100 wt.-%, more preferably of from 99 to 100 wt.-%, more preferably of from 99.5 to 100 wt.-%, and more preferably of from 99.9 to 100 wt.-%.

Further in the case wherein the NH₃-reforming catalyst C1 contained in the reactor provided in (i) comprises Ru and one or more support materials, wherein Ru is supported on the one or more support materials, it is preferred that Ru is supported on the one or more support materials by an impregnation technique employing an aqueous solution of one or more ruthenium salts, wherein the one or more ruthenium salts more preferably comprise Ru(NO)(NO₃)₃, wherein more preferably Ru(NO)(NO₃)₃ is employed as the one or more ruthenium salts.

Further in the case wherein the NH₃-reforming catalyst C1 contained in the reactor provided in (i) comprises Ru and one or more support materials, wherein Ru is supported on the one or more support materials, it is preferred that the one or more support materials are selected from the group consisting of metal oxides, wherein the metal of the metal oxides is preferably selected from the group consisting of Al, Si, Ti, Zr, Hf, V, Nb, Ta, Cr, Mo, W, Mn, alkaline earth metals, and rare earth metals, including combinations of two or more thereof, more preferably from the group consisting of Al, Si, Ti, Zr, Mg, Ca, La, Ce, Pr, and Nd, including combinations of two or more thereof, more preferably from the group consisting of Al, Ti, Zr, Mg, Ca, and La, including combinations of two or more thereof, and more preferably from the group consisting of Al, Zr, and Mg, including combinations of two or more thereof, wherein more preferably the one or more support materials comprise one or more metal oxides selected from the group consisting of Al₂O₃, ZrO₂, and spinels, including mixtures of two or more thereof, preferably from the group consisting of ZrO₂ and spinels, including mixtures of two or more thereof, wherein more preferably the one or more support materials comprise ZrO₂ and/or MgAl₂O₄, preferably ZrO₂, wherein more preferably the one or more support materials consist of ZrO₂ and/or MgAl₂O₄, preferably of ZrO₂.

In the case wherein the one or more support materials comprise ZrO₂, it is preferred that the ZrO₂ comprises one or more crystalline phases and/or is amorphous, wherein the one or more crystalline phases of ZrO₂ are selected from the group consisting of the monoclinic, tetragonal, and cubic phases of ZrO₂, including mixtures of two or three thereof.

Further in the case wherein the NH₃-reforming catalyst C1 contained in the reactor provided in (i) comprises Ru and one or more support materials, wherein Ru is supported on the one or more support materials, it is preferred that the one or more support materials contain substantially no CaO and/or MgO, more preferably substantially no CaO and MgO, more preferably substantially no alkaline earth metal oxide, more preferably substantially no Ca and/or Mg, more preferably substantially no Ca and Mg, and more preferably substantially no alkaline earth metal.

Further in the case wherein the NH₃-reforming catalyst C1 contained in the reactor provided in (i) comprises Ru and one or more support materials, wherein Ru is supported on the one or more support materials, it is preferred that the one or more support materials contain substantially no Al₂O₃ and/or SiO₂, more preferably substantially no Al₂O₃ and SiO₂, more preferably substantially no Al and/or Si, and more preferably substantially no Al and Si.

Further in the case wherein the NH₃-reforming catalyst C1 contained in the reactor provided in (i) comprises Ru and one or more support materials, wherein Ru is supported on the one or more support materials, it is preferred that the one or more support materials contain substantially no carbon nanotubes, more preferably substantially no elemental carbon, and more preferably substantially no carbon.

Further in the case wherein the NH₃-reforming catalyst C1 contained in the reactor provided in (i) comprises Ru and one or more support materials, wherein Ru is supported on the one or more support materials, it is preferred that the NH₃ reforming catalyst C1 comprises Ru in an amount in the range of from 0.1 to 15 wt.-% based on 100 wt.-% of the total amount of the one or more support materials, more preferably of from 1 to 10 wt.-%, more preferably of from 2 to 8 wt.-%, more preferably of from 3 to 6.5 wt.-%, more preferably of from 4 to 6 wt.-%, and more preferably of from 4.5 to 5.5 wt.-%.

Further in the case wherein the NH₃-reforming catalyst C1 contained in the reactor provided in (i) comprises Ru and one or more support materials, wherein Ru is supported on the one or more support materials, it is preferred that from 95 to 100 wt.-% of the NH₃ reforming catalyst C1 consists of Ru and the one or more support materials, more preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.

Further in the case wherein the NH₃-reforming catalyst C1 contained in the reactor provided in (i) comprises Ru and one or more support materials, wherein Ru is supported on the one or more support materials, it is preferred that the NH₃ reforming catalyst C1 contained in the reactor provided in (i) further comprises one or more alkali metal and/or alkaline earth metal hydroxides, wherein the one or more alkali metal and/or alkaline earth metal hydroxides are supported on the one or more support materials supporting Ru, wherein the alkali metal and/or alkaline earth metal hydroxides are more preferably selected from the group consisting of Mg(OH)₂, Ca(OH)₂, Ba(OH)₂, Sr(OH)₂, LiOH, NaOH, and KOH, including mixtures of two or more thereof, more preferably from the group consisting of Mg(OH)₂, Ca(OH)₂, LiOH, NaOH, and KOH, including mixtures of two or more thereof, more preferably from the group consisting of LiOH, NaOH, and KOH, including mixtures of two or more thereof, wherein more preferably the catalyst further comprises KOH and/or LiOH, preferably KOH.

In the case wherein the NH₃ reforming catalyst C1 contained in the reactor provided in (i) further comprises one or more alkali metal and/or alkaline earth metal hydroxides, wherein the one or more alkali metal and/or alkaline earth metal hydroxides are supported on the one or more support materials supporting Ru, it is preferred that the NH₃ reforming catalyst C1 contained in the reactor provided in (i) comprises the one or more alkali metal hydroxides in an amount in the range of from 0.5 to 15 wt.-% based on 100 wt.-% of the total amount of the one or more support materials, more preferably of from 1 to 10 wt.-%, more preferably of from 2 to 8 wt.-%, more preferably of from 3 to 6.5 wt.-%, more preferably of from 4 to 6 wt.-%, and more preferably of from 4.5 to 5.5 wt.-%.

Further in the case wherein the NH₃ reforming catalyst C1 contained in the reactor provided in (i) further comprises one or more alkali metal and/or alkaline earth metal hydroxides, wherein the one or more alkali metal and/or alkaline earth metal hydroxides are supported on the one or more support materials supporting Ru, it is preferred that from 95 to 100 wt.-% of the NH₃ reforming catalyst C1 contained in the reactor provided in (i) consists of Ru, the one or more alkali metal hydroxides, and the one or more support materials, more preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.

Further in the case wherein the NH₃-reforming catalyst C1 contained in the reactor provided in (i) comprises Ru and one or more support materials, wherein Ru is supported on the one or more support materials, it is preferred that the NH₃ reforming catalyst C1 contained in the reactor provided in (i) is in the form of a molding and/or in powder form, preferably in the form of a molding, and more preferably in the form of extrudates or tablets.

In the case wherein the NH₃ reforming catalyst C1 contained in the reactor provided in (i) is in the form of extrudates, it is preferred that the extrudates have a diameter in the range of from 0.5 to 10 mm, more preferably of from 1 to 7 mm, more preferably of from 1.5 to 5 mm, more preferably of from 2 to 4 mm, and more preferably of from 2.5 to 3.5 mm.

Further in the case wherein the NH₃ reforming catalyst C1 contained in the reactor provided in (i) is in the form of extrudates, it is preferred that the extrudates are split, and the NH₃ reforming catalyst C1 contained in the reactor provided in (i) is in the form of extrudates of a split sieve fraction in the range of from 50 μm to 2.5 mm, more preferably of from 100 μm to 1.5 mm, more preferably of from 200 μm to 1 mm, more preferably of from 250 to 700 μm, and more preferably of from 300 to 500 μm.

In the case wherein the NH₃ reforming catalyst C1 contained in the reactor provided in (i) is in the form of extrudates of a split sieve fraction in the range of from 50 μm to 2.5 mm, it is preferred that the tablets have a four-hole cross-section, more preferably a four-hole cross-section and four flutes.

The present invention is further illustrated by the following set of embodiments and combinations of embodiments resulting from the dependencies and back-references as indicated. In particular, it is noted that in each instance where a range of embodiments is mentioned, for example in the context of a term such as “The process of any one of embodiments 1 to 4”, every embodiment in this range is meant to be explicitly disclosed for the skilled person, i.e. the wording of this term is to be understood by the skilled person as being synonymous to “The process of any one of embodiments 1, 2, 3, and 4”.

Further, it is explicitly noted that the following set of embodiments is not the set of claims determining the extent of protection, but represents a suitably structured part of the description directed to general and preferred aspects of the present invention.
1. A process for NH₃ reforming, the process comprising
   (i) providing a reactor containing an NH₃-reforming catalyst C1 comprising a metal M1 selected from the group consisting of groups 6 to 11 of the periodic table, including mixtures of two or more thereof;
   (ii) preparing a feed gas stream F1 containing NH₃;
   (iii) feeding F1 prepared according to (ii) into the reactor and contacting F1 with the NH₃-reforming catalyst C1, wherein the reactor has a temperature of 100° C. or more; obtaining a product gas stream P1 comprising H₂O, and an NH₃-reforming catalyst C2;
   wherein feeding according to (ii) is started at a point in time t1;
   wherein at a point in time t2 the H₂O(P1):H₂O(F1) molar ratio of H₂O in the product gas stream P1 to H₂O in the feed gas stream F1 is greater than 1:1, wherein the H₂O in the product gas stream P1 and the H₂O in the feed gas stream F1 are preferably determined according to DIN EN 14790, more preferably according to Reference Example 1, wherein the difference between t2 and t1 is in the range of from 5 s to 10 days.
2. The process of embodiment 1, wherein at a point in time t2 the H₂O(P1):H₂O(F1) molar ratio of H₂O in the product gas stream P1 to H₂O in the feed gas stream F1 is in the range of from 1.0001:1 to 25:1, preferably in the range of from 1.0005:1 to 15:1, more preferably in the range of from 1.001:1 to 10:1, more preferably in the range of from 1.005:1 to 5:1, more preferably in the range of from 1.01:1 to 4:1, more preferably in the range of from 1.05:1 to 3:1, more preferably in the range of from 1.1:1 to 2:1.
3. The process of embodiment 1 or 2, wherein the difference between t2 and t1 is in the range of from 5 s to 9 d, preferably in the range of from 1 min to 8 d, more preferably in the range of from 5 min to 7 d, more preferably in the range of from 0.5 h to 5 d, more preferably in the range of from 1 h to 4 d, more preferably in the range of from 3 h to 2 d, more preferably in the range of from 6 h to 2 d.
4. The process of any one of embodiments 1 to 3, wherein the X-ray diffractogram of the NH₃-reforming catalyst C1 contained in the reactor provided in (i) displays one or more crystalline phases of one or more oxides of M1, preferably determined according to Reference Example 2.
5. The process of any one of embodiments 1 to 4, wherein the X-ray diffractogram of the NH₃-reforming catalyst C2 obtained from (iii) displays one or more crystalline phases of elemental M1, preferably determined according to Reference Example 2.
6. The process of any one of embodiments 1 to 5, wherein the X-ray diffractogram of the NH₃-reforming catalyst C2 obtained from (iii) does not display any crystalline phases of one or more oxides of M1, preferably determined according to Reference Example 2.
7. The process of any one of embodiments 1 to 6, wherein M1 is selected from the group consisting of Ru, Ni, Rh, Co, Ir, Fe, Pt, Cr, Pd, Cu, and mixtures of two or more thereof, preferably from the group consisting of Ni, Co, Ru, Fe and a mixture thereof.
8. The process of embodiment 7, wherein M1 comprises, preferably is, Ni.
9. The process of embodiment 8, wherein the XRD pattern of the NH₃-reforming catalyst C1 contained in the reactor provided in (i) displays a weight ratio of a NiO crystalline phase to an elemental Ni crystalline phase of greater than 1:100, preferably of greater than 1:10, more preferably in the range of from 1:10 to 100:1, more preferably in the range of from 1:10 to 10:1, wherein the XRD pattern is preferably determined according to Reference Example 2.
10. The process of embodiment 8 or 9, wherein the TPR profile of the NH₃-reforming catalyst C1 contained in the reactor provided in (i) displays a first peak having a maximum in the range of from 100 to 400° C., preferably in the range of from 120 to 350° C., more preferably in the range of from 150 to 250° C., wherein the TPR profile is preferably determined according to Reference Example 3.
11. The process of embodiment 10, wherein the integration of the first peak affords a value in the range of from 500 to 4000 μmol/g, preferably in the range of from 1500 to 3000 μmol/g, more preferably in the range of from 2000 to 2500 μmol/g.
12. The process of embodiment 10 or 11, wherein the TPR profile of the NH₃-reforming catalyst C1 contained in the reactor provided in (i) displays a second peak having a maximum in the range of from greater than 400 to 900° C., preferably in the range of from 425 to 850° C., more preferably in the range of from 450 to 800° C., wherein the TPR profile is preferably determined according to Reference Example 3.
13. The process of embodiment 12, wherein the integration of the second peak affords a value in the range of from 500 to 4500 μmol/g, preferably in the range of from 1500 to 3500 μmol/g, more preferably in the range of from 2000 to 3000 μmol/g.
14. The process of any one of embodiments 10 to 13, wherein the TPR profile of the NH₃-reforming catalyst C1 contained in the reactor provided in (i) displays a third peak having a maximum in the range of from greater than 900 to 1300° C., preferably in the range of from 950 to 1250° C., more preferably in the range of from 1000 to 1200° C., wherein the TPR profile is preferably determined according to Reference Example 3.
15. The process of embodiment 14, wherein the integration of the third peak affords a value in the range of from 100 to 1500 μmol/g, preferably in the range of from 300 to 1250 μmol/g, more preferably in the range of from 500 to 1000 μmol/g.
16. The process of embodiment 7, wherein M1 comprises, preferably is, Ru.
17. The process embodiment 16, wherein the TPR profile of the NH₃-reforming catalyst C1 contained in the reactor provided in (i) displays a peak having a maximum in the range of from 100 to 400° C., preferably in the range of from 120 to 350° C., more preferably in the range of from 150 to 250° C., wherein the TPR profile is preferably determined according to Reference Example 3.
18. The process of embodiment 17, wherein the integration of the peak affords a value in the range of from 1500 to 5000 μmol/g, preferably in the range of from 2500 to 4000 μmol/g, more preferably in the range of from 3000 to 3500 μmol/g.
19. The process of any one of embodiments 1 to 18, wherein the reactor provided in (i) has a length in the range of from 0.5 to 20 m, preferably in the range of from 1 to 12 m.
20. The process of any one of embodiments 1 to 19, wherein the reactor provided in (i) is operated in adiabatic mode.
21. The process of any one of embodiments 1 to 20, wherein the reactor provided in (i) is directly heated, preferably flame-heated or electrically heated.
22. The process of any one of embodiments 1 to 21, wherein the feed gas stream F1 prepared according to (ii) comprises from 0 to 0.5 volume-%, preferably from 0 to 0.2 volume-%, more preferably from 0 to 0.1 volume-%, more preferably from 0 to 0.05 volume-%, more preferably from 0 to 0.02 volume-%, more preferably from 0 to 0.01 volume-%, more preferably from 0 to 0.005 volume-%, more preferably from 0 to 0.002 volume-%, more preferably from 0 to 0.001 volume-%, of H₂.
23. The process of any one of embodiments 1 to 22, wherein the feed gas stream F1 prepared according to (ii) comprises from 1 to 100 volume-%, preferably from 2 to 100 volume-%, more preferably from 4 to 100 volume-%, more preferably from 5 to 100 volume-%, more preferably from 50 to 100 volume-%, more preferably from 80 to 100 volume-%, more preferably from 85 to 100 volume-%, more preferably from 89.5 to 100 volume-%, preferably from 94.5 to 100 volume-%, more preferably from 99.0 to 100 volume-%, more preferably from 99.5 to 100 volume-%, more preferably from 99.6 to 100 volume-%, more preferably from 99.7 to 100 volume-%, more preferably from 99.8 to 100 volume-%, more preferably from 99.9 to 100 volume-%, more preferably from 99.95 to 100 volume-%, more preferably from 99.98 to 100 volume-%, more preferably from 99.99 to 100 volume-%, of NH₃.
24. The process of any one of embodiments 1 to 23, wherein the feed gas stream F1 prepared according to (ii) has an NH₃ partial pressure in the range of from 0.01 to 65 bara, preferably in the range of from 0.05 to 45 bara, more preferably in the range of from 0.1 to 25 bara, more preferably in the range of from 0.5 to 15 bara, more preferably in the range of from 1 to 10 bara.
25. The process of any one of embodiments 1 to 24, wherein the feed gas stream F1 prepared according to (ii) comprises from 0 to 1 volume-%, preferably from 0 to 0.8 volume-%, more preferably from 0.0001 to 0.7 volume-%, more preferably from 0.0001 to 0.6 volume-%, more preferably from 0.03 to 0.5 volume-%, more preferably from 0.05 to 0.4 volume-%, of H₂O.
26. The process of any one of embodiments 1 to 25, wherein the feed gas stream F1 prepared according to (ii) comprises from 0 to 99 volume-%, preferably from 98 volume-%, more preferably from 0 to 96 volume-%, more preferably from 0 to 95 volume-%, more preferably from 0 to 50 volume-%, more preferably from 0 to 30 volume-%, more preferably from 0 to 20 volume-%, more preferably from 0 to 10 volume-%, more preferably from 0 to 5 volume-%, of an inert gas, wherein the inert gas comprises, preferably consists of, one or more of Ar and N₂, preferably N₂.
27. The process of any one of embodiments 1 to 26, wherein from 99 to 100 volume-%, preferably from 99.9 to 100 volume-%, more preferably from 99.99 to 100 volume-%, of the feed gas stream F1 prepared according to (ii) consists of NH₃, H₂, optionally H₂O, and optionally an inert gas, wherein the inert gas comprises, preferably consists of, one or more of Ar and N₂, preferably N₂.
28. The process of any one of embodiments 1 to 27, wherein the feed gas stream F1 prepared according to (ii) is fed into the reactor according to (iii) having a gas hourly space velocity in the range of from 100 to 15,000 h⁻¹, preferably in the range of from 500 to 10,000 h⁻¹, more preferably in the range of from 1000 to 5000 h⁻¹, more preferably in the range of from 2000 to 4750 h⁻¹, more preferably in the range of from 3500 to 4500 h⁻¹.
29. The process of any one of embodiments 1 to 28, wherein contacting according to (iii) is performed at a pressure in the range of from 1 to 65 bara, preferably of from 2 to 50 bara, more preferably of from 4 to 35 bara, more preferably of from 5 to 10 bara.
30. The process of any one of embodiments 1 to 29, wherein contacting according to (iii) is performed at a temperature in the range of from 200 to 1000° C., preferably of from 350 to 800° C., more preferably of from 450 to 650° C.
31. The process of any one of embodiments 1 to 30, further comprising
   (iv) preparing a feed gas stream F2 comprising NH₃;
   (v) feeding the feed gas stream F2 prepared according to (iv) into the reactor and contacting the feed gas stream F2 with the NH₃-reforming catalyst C2 obtained from (iii);
   (vi) removing an effluent gas stream from the reactor, the effluent gas stream comprising H₂ and N₂.
32. The process of embodiment 31 embodiment, wherein the feed gas stream F2 prepared according to (iv) comprises from 0 to 0.5 volume-%, preferably from 0 to 0.2 volume-%, more preferably from 0 to 0.1 volume-%, more preferably from 0 to 0.05 volume-%, more preferably from 0 to 0.02 volume-%, more preferably from 0 to 0.01 volume-%, more preferably from 0 to 0.005 volume-%, more preferably from 0 to 0.002 volume-%, more preferably from 0 to 0.001 volume-%, of H₂.
33. The process of embodiment 31 or 32 embodiment, wherein the feed gas stream F2 prepared according to (iv) comprises from 1 to 100 volume-%, preferably from 2 to 100 volume-%, more preferably from 4 to 100 volume-%, more preferably from 5 to 100 volume-%, more preferably from 50 to 100 volume-%, more preferably from 80 to 100 volume-%, more preferably from 85 to 100 volume-%, more preferably from 89.5 to 100 volume-%, preferably from 94.5 to 100 volume-%, more preferably from 99.0 to 100 volume-%, more preferably from 99.5 to 100 volume-%, more preferably from 99.6 to 100 volume-%, more preferably from 99.7 to 100 volume-%, of NH₃.
34. The process of any one of embodiments 31 to 33, wherein the feed gas stream F2 prepared according to (iv) comprises from 0 to 1 volume-%, preferably from 0 to 0.8 volume-%, more preferably from 0.0001 to 0.7 volume-%, more preferably from 0.0001 to 0.5 volume-%, more preferably from 0.0005 to 0.4 volume-%, more preferably from 0.001 to 0.3, of H₂O.
35. The process of any one of embodiments 31 to 34, wherein the feed gas stream F2 prepared according to (iv) comprises from 0 to 99 volume-%, preferably from 98 volume-%, more preferably from 0 to 96 volume-%, more preferably from 0 to 95 volume-%, more preferably from 0 to 50 volume-%, more preferably from 0 to 30 volume-%, more preferably from 0 to 20 volume-%, more preferably from 0 to 10 volume-%, more preferably from 0 to 5 volume-%, of an inert gas, wherein the inert gas comprises, preferably consists of, one or more of Ar and N₂, preferably N₂.
36. The process of any one of embodiments 31 to 35, wherein from 99 to 100 volume-%, preferably from 99.9 to 100 volume-%, more preferably from 99.99 to 100 volume-%, of the feed gas stream F2 prepared according to (iv) consists of NH₃, H₂, optionally H₂O, and optionally an inert gas, wherein the inert gas comprises, preferably consists of, one or more of Ar and N₂, preferably N₂.
37. The process of any one of embodiments 31 to 36, wherein the feed gas stream F2 prepared according to (iv) has the same chemical composition as the feed gas stream F1 prepared according to (ii).
38. The process of any one of embodiments 31 to 37, wherein the feed gas stream F2 prepared according to (iv) is fed into the reactor according to (v) having a gas hourly space velocity in the range of from 500 to 15,000 h⁻¹, preferably in the range of from 1000 to 10,000 h⁻¹, more preferably in the range of from 2000 to 8000 h⁻¹, more preferably in the range of from 3250 to 6000 h⁻¹, more preferably in the range of from 3500 to 5000 h⁻¹.
39. The process of any one of embodiments 31 to 38, wherein contacting according to (v) is performed at a pressure in the range of from 10 to 65 bara, preferably of from 20 to 55 bara, more preferably of from 30 to 50 bara, more preferably of from 35 to 45 bara.
40. The process of any one of embodiments 31 to 39, wherein contacting according to (v) is performed at a temperature in the range of from 200 to 950° C., preferably of from 250 to 800° C., preferably of from 300 to 700° C., more preferably of from 325 to 600° C., more preferably of from 350 to 550° C.
41. The process of any one of embodiments 1 to 40, wherein the NH₃-reforming catalyst C1 contained in the reactor provided in (i) further comprises a metal M2 selected from the group consisting of alkali metals, alkaline earth metals, Mo, Fe, Ru, and mixtures of two or more thereof, preferably from the group consisting of Li, K, Na, Cs, Mg, Ca, Sr, Ba, Mo, Fe, Ru, and mixtures of two or more thereof, more preferably from the group consisting of K, Na, Cs, Ba, Mo, Fe, Ru, and mixtures of two or more thereof, more preferably from the group consisting of K, Ba, Mo, Fe, Ru, and mixtures of two or more thereof, more preferably from the group consisting of Fe, Ru, and a mixture thereof, wherein M2 more preferably is Ru.
42. The process of embodiment 41, wherein the NH₃-reforming catalyst C1 contained in the reactor provided in (i) further comprises one or more support materials onto which one or more of M1 and M2, preferably M1 and M2, are supported, wherein the one or more support materials are preferably selected from the group consisting of Al₂O₃, SiO₂, ZrO₂, CeO₂, MgO, CaO, and mixtures of two or more thereof, more preferably from the group consisting of Al₂O₃, SiO₂, ZrO₂, CeO₂, and mixtures of two or more thereof, more preferably from the group consisting of Al₂O₃, SiO₂, and mixtures thereof, wherein more preferably the support material comprises Al₂O₃.
43. The process of embodiment 41 or 42 embodiment, wherein the NH₃-reforming catalyst C1 contained in the reactor provided in (i) further displays an M2:M1 atomic ratio in the range of from 0.1:99.9 to 80:20, preferably of from 0.5:99.5 to 75:25, more preferably of from 1:99 to 70:30, more preferably of from 5:95 to 65:35, more preferably of from 15:85 to 60:40, more preferably of from 30:70 to 55:45, and more preferably of from 40:60 to 50:50.
44. The process of any one of embodiments 41 to 43, wherein M2 comprises, preferably is, Fe or Co, and wherein the NH₃-reforming catalyst C1 contained in the reactor provided in (i) displays an M2:M1 atomic ratio in the range of from 1:99 to 80:20, preferably of from 5:95 to 75:25, more preferably of from 10:90 to 70:30, more preferably of from 20:80 to 65:35, more preferably of from 30:70 to 60:40, more preferably of from 35:65 to 55:45, and more preferably of from 40:60 to 50:50.
45. The process of any one of embodiments 41 to 44, wherein M2 comprises, preferably is, Ru, and wherein the NH₃-reforming catalyst C1 contained in the reactor provided in (i) displays an M2:M1 atomic ratio in the range of from 0.1:99.9 to 30:70, preferably of from 0.5:99.5 to 30:70, more preferably of from 1:99 to 20:80, more preferably of from 3:97 to 10:90, and more preferably of from 5:95 to 6:94.
46. The process of any one of embodiments 41 to 45, wherein the NH₃-reforming catalyst C1 contained in the reactor provided in (i) further comprises Al and O.
47. The process of embodiment 46, wherein the NH₃-reforming catalyst C1 contained in the reactor provided in (i) comprises Ni as the metal M1, wherein preferably the metal M1 is Ni.
48. The process of embodiment 47, wherein the NH₃-reforming catalyst C1 contained in the reactor provided in (i) further comprises Mg, wherein the Ni:Mg:Al molar ratio is preferably in the range of from 1:(0.1-12):(0.5-20), more preferably of from 1:(0.5-8):(1-12), more preferably of from 1:(1-5):(3-8), more preferably of from 1:(1.5-3):(3.5-5), and more preferably of from 1:(2.0-2.4):(4.0-4.4).
49. The process of embodiment 47 or 48, wherein from 95 to 100 wt.-% of the NH₃-reforming catalyst C1 contained in the reactor provided in (i) consists of Ni, Mg, Al, and O, preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.
50. The process of embodiment 47 or 48, wherein from 95 to 100 wt.-% of the NH₃-reforming catalyst C1 contained in the reactor provided in (i) consists of M2, Ni, Mg, Al, and O, preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.
51. The process of embodiment 46, wherein the NH₃-reforming catalyst C1 contained in the reactor provided in (i) comprises Co as the metal M1, wherein preferably the metal M1 is Co.
52. The process of embodiment 52, wherein the NH₃-reforming catalyst C1 contained in the reactor provided in (i) further comprises La, wherein the Co:La:Al molar ratio is preferably in the range of from 1:(0.1-8):(1-50), more preferably of from 1:(0.5-5):(3-30), more preferably of from 1:(0.8-3):(5-20), more preferably of from 1:(1-2):(8-15), and more preferably of from 1:(1.3-1.7):(10-12).
53. The process of embodiment 51 or 52, wherein from 95 to 100 wt.-% of the NH₃-reforming catalyst C1 contained in the reactor provided in (i) consists of Co, La, Al, and O, preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.
54. The process of embodiment 51 or 52, wherein from 95 to 100 wt.-% of the NH₃-reforming catalyst C1 contained in the reactor provided in (i) consists of M2, Co, La, Al, and O, preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.
55. The process of any one of embodiments 1 to 54, wherein the NH₃-reforming catalyst C1 contained in the reactor provided in (i) is in form of a molding.
56. The process of embodiment 55, wherein the molding is a tablet.
57. The process of embodiment 56, wherein the tablet has a four-hole cross-section, preferably a four-hole cross-section having a diameter in the range of from 5 to 19 mm, more preferably in the range of from 8 to 18 mm, more preferably in the range of from 16.7 to 16.8 mm, and a height in the range of from 7 to 11 mm, preferably in the range of from 9.5 to 10.5 mm, more preferably in the range of from 9.7 to 10.0 mm.
58. The process of embodiment 57, wherein the tablet is a calcined tablet, wherein the calcination has preferably been performed in a gas atmosphere having a temperature in the range of from 350 to 450° C., more preferably in the range of from 360 to 440° C., more preferably in the range of from 375 to 425° C., more preferably in the range of from 390 to 410° C., wherein the gas atmosphere more preferably comprised oxygen, more preferably was one or more of oxygen, air, or lean air, wherein the calcining was performed more preferably for 0.5 to 20, more preferably for 1 to 15 h, more preferably for 2 to 10 h, more preferably for 3 to 5 h.
59. The process of embodiment 57 or 58, wherein the tablet has a side crushing strength 1 (SCS1) of at least 70 N, preferably in the range of from 70 to 250 N, more preferably in the range of from 70 to 130 N, determined as described in Reference Example 5, wherein four cylindrical segments are located in an area each between two flutes, wherein the side crushing strength 1 is measured according to Reference Example 5 in a condition where the tablet stands on two cylindrical segments sided by a flute.
60. The process of any one of embodiments 57 to 59, wherein the tablet has a side crushing strength 2 (SCS2) of at least 60 N, preferably in the range of from 60 to 200 N, more preferably in the range of from 60 to 88 N, determined as described in Reference Example 5, wherein four cylindrical segments are located in an area each between two flutes, wherein the side crushing strength 2 is measured according to Reference Example 5 in a condition where the tablet stands on a cylindrical segment.
61. The process of any one of embodiments 57 to 60, wherein the tablet has a side crushing strength 3 (SCS3) of at least 190 N, preferably in the range of from 190 to 350 N, more preferably in the range of from 190 to 240 N, determined as described in Reference Example 5, wherein four cylindrical segments are located in an area each between two flutes, wherein the side crushing strength 3 is measured according to Reference Example 5 in a condition where the area of the cylindrical segments is perpendicular to the direction of the force applied on the tablet.
62. The process of embodiment 56, wherein the tablet has a four-hole cross-section, preferably a four-hole cross-section having a diameter in the range of from 10 to 18 mm, more preferably in the range of from 13.5 to 16.0 mm, more preferably in the range of from 14.0 to 15.5 mm, and a height in the range of from 5 to 11 mm, more preferably in the range of from 7.5 to 9.4 mm, more preferably in the range of from 8.2 to 9.0 mm.
63. The process of embodiment 62, wherein the tablet is a calcined tablet, wherein the calcination has preferably been performed in a gas atmosphere having a temperature in the range of from 800 to 1400° C., more preferably in the range of from 875 to 1275° C., more preferably in the range of from 950 to 1250° C., more preferably in the range of from 1050 to 1225° C., wherein the gas atmosphere more preferably comprised oxygen, more preferably was one or more of oxygen, air, or lean air, wherein the calcining was performed more preferably for 0.5 to 20 h, more preferably for 1 to 15 h, more preferably for 2 to 10 h, more preferably for 3 to 5 h.
64. The process of embodiment 62 or 63, wherein the tablet has a side crushing strength 1 (SCS1) of at least 366 N, preferably of at least 400 N, more preferably in the range of from 400 to 800 N, more preferably in the range of from 400 to 600 N, more preferably in the range of from 400 to 570 N, determined as described in Reference Example 4, the molding more preferably being a tablet having a four-hole cross-section and having four flutes, wherein four cylindrical segments are located in an area each between two flutes, wherein the side crushing strength 1 is measured according to Reference Example 4 in a condition where the tablet stands on two cylindrical segments sided by a flute.
65. The process of any one of embodiments 62 to 64, wherein the tablet has a side crushing strength 2 (SCS2) of at least 170 N, preferably of at least 190 N, more preferably in the range of from 190 to 450 N, more preferably in the range of from 190 to 300 N, more preferably in the range of from 190 to 270 N, determined as described in Reference Example 4, wherein four cylindrical segments are located in an area each between two flutes, wherein the side crushing strength 2 is measured according to Reference Example 4 in a condition where the tablet stands on a cylindrical segment.
66. The process of any one of embodiments 62 to 65, wherein the tablet has a side crushing strength 3 (SCS3) of at least 345 N, preferably of at least 500 N, more preferably in the range of from 500 to 950 N, more preferably in the range of from 500 to 800 N, more preferably in the range of from 500 to 770 N, determined as described in Reference Example 4, wherein four cylindrical segments are located in an area each between two flutes, wherein the side crushing strength 3 is preferably measured according to Reference Example 4 in a condition where the area of the cylindrical segments is perpendicular to the direction of the force applied on the tablet.
67. The process of any one of embodiments 1 to 7 and 16 to 4066, wherein the NH₃-reforming catalyst C1 contained in the reactor provided in (i) comprises Ru and one or more support materials, wherein Ru is supported on the one or more support materials.
68. The process of embodiment 67, wherein the NH₃-reforming catalyst C1 contained in the reactor provided in (i) comprises 1 wt.-% or less, preferably 0.5 wt.-%, more preferably 0.1 wt.-% or less, more preferably 0.05 wt.-% or less, more preferably 0.01 wt.-% or less, more preferably 0.005 wt.-% or less, and more preferably 0.001 wt.-% or less, of Ni and Co calculated as the respective element and based on 100 wt.-% of the NH₃-reforming catalyst C1.
69. The process of embodiment 67 or 68, wherein the one or more support materials display a BET surface area of 20 m²/g or more, preferably in the range of from 30 to 800 m²/g, more preferably of from 40 to 500 m²/g, more preferably of from 50 to 300 m²/g, more preferably of from 60 to 200 m²/g, more preferably of from 70 to 100 m²/g, and more preferably of from 75 to 80 m²/g, wherein the BET surface area is preferably determined according to ISO 9277:2010.
70. The process of embodiment 67 or 68, wherein the one or more support materials display a BET surface area of 20 m²/g or more, preferably in the range of from greater than 20 to 150 m²/g, more preferably of from 21 to 100 m²/g, more preferably of from 22 to 70 m²/g, more preferably of from 23 to 50 m²/g, more preferably of from 24 to 40 m²/g, and more preferably of from 25 to 35 m²/g, wherein the BET surface area is preferably determined according to ISO 9277:2010.
71. The process of any one of embodiments 67 to 70, wherein the one or more support materials display a pore volume in the range of from 0.2 to 3 ml/g, preferably of from 0.4 to 1.5 ml/g, more preferably of from 0.6 to 1 ml/g, and more preferably of from 0.8 to 0.85 ml/g, wherein the pore volume is preferably determined according to ISO 15901-2:2022.
72. The process of any one of embodiments 67 to 71, wherein the NH₃ reforming catalyst C1 contained in the reactor provided in (i) displays a BET surface area in the range of 20 to 800 m²/g, preferably of from 30 to 500 m²/g, more preferably of from 40 to 300 m²/g, more preferably of from 50 to 200 m²/g, more preferably of from 60 to 100 m²/g, and more preferably of from 70 to 75 m²/g, wherein the BET surface area is preferably determined according to ISO 9277:2010.
73. The process of any one of embodiments 67 to 72, wherein the NH₃ reforming catalyst C1 contained in the reactor provided in (i) displays a pore volume in the range of 0.1 to 2 ml/g, preferably of from 0.15 to 1.2 ml/g, more preferably of from 0.2 to 0.8 ml/g, more preferably of from 0.25 to 0.5 ml/g, and more preferably of from 0.3 to 0.35 ml/g, wherein the pore volume is preferably determined according to ISO 15901-2:2022.
74. The process of any one of embodiments 67 to 73, from 90 to 100 wt.-% of Ru calculated as the element, and based on 100 wt.-% of Ru contained in the NH₃ reforming catalyst C1 contained in the reactor provided in (i), is supported on the one or more support materials comprised in the catalyst, preferably of from 95 to 100 wt.-%, more preferably of from 99 to 100 wt.-%, more preferably of from 99.5 to 100 wt.-%, and more preferably of from 99.9 to 100 wt.-%.
75. The process of any one of embodiments 67 to 74, wherein Ru is supported on the one or more support materials by an impregnation technique employing an aqueous solution of one or more ruthenium salts, wherein the one or more ruthenium salts preferably comprise Ru(NO)(NO₃)₃, wherein more preferably Ru(NO)(NO₃)₃ is employed as the one or more ruthenium salts.
76. The process of any one of embodiments 67 to 75, wherein the one or more support materials are selected from the group consisting of metal oxides, wherein the metal of the metal oxides is preferably selected from the group consisting of Al, Si, Ti, Zr, Hf, V, Nb, Ta, Cr, Mo, W, Mn, alkaline earth metals, and rare earth metals, including combinations of two or more thereof, more preferably from the group consisting of Al, Si, Ti, Zr, Mg, Ca, La, Ce, Pr, and Nd, including combinations of two or more thereof, more preferably from the group consisting of Al, Ti, Zr, Mg, Ca, and La, including combinations of two or more thereof, and more preferably from the group consisting of Al, Zr, and Mg, including combinations of two or more thereof, wherein more preferably the one or more support materials comprise one or more metal oxides selected from the group consisting of Al₂O₃, ZrO₂, and spinels, including mixtures of two or more thereof, preferably from the group consisting of ZrO₂ and spinels, including mixtures of two or more thereof, wherein more preferably the one or more support materials comprise ZrO₂ and/or MgAl₂O₄, preferably ZrO₂, wherein more preferably the one or more support materials consist of ZrO₂ and/or MgAl₂O₄, preferably of ZrO₂.
77. The process of embodiment 76, wherein the ZrO₂ comprises one or more crystalline phases and/or is amorphous, wherein the one or more crystalline phases of ZrO₂ are selected from the group consisting of the monoclinic, tetragonal, and cubic phases of ZrO₂, including mixtures of two or three thereof.
78. The process of any one of embodiments 67 to 77, wherein the one or more support materials contain substantially no CaO and/or MgO, preferably substantially no CaO and MgO, more preferably substantially no alkaline earth metal oxide, more preferably substantially no Ca and/or Mg, more preferably substantially no Ca and Mg, and more preferably substantially no alkaline earth metal.
79. The process of any one of embodiments 67 to 78, wherein the one or more support materials contain substantially no Al₂O₃ and/or SiO₂, preferably substantially no Al₂O₃ and SiO₂, more preferably substantially no Al and/or Si, and more preferably substantially no Al and Si.
80. The process of any one of embodiments 67 to 79, wherein the one or more support materials contain substantially no carbon nanotubes, preferably substantially no elemental carbon, and more preferably substantially no carbon.
81. The process of any one of embodiments 67 to 80, wherein the NH₃ reforming catalyst C1 comprises Ru in an amount in the range of from 0.1 to 15 wt.-% based on 100 wt.-% of the total amount of the one or more support materials, preferably of from 1 to 10 wt.-%, more preferably of from 2 to 8 wt.-%, more preferably of from 3 to 6.5 wt.-%, more preferably of from 4 to 6 wt.-%, and more preferably of from 4.5 to 5.5 wt.-%.
82. The process of any one of embodiments 67 to 81, wherein from 95 to 100 wt.-% of the NH₃ reforming catalyst C1 consists of Ru and the one or more support materials, preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.
83. The process of any one of embodiments 67 to 82, wherein the NH₃ reforming catalyst C1 contained in the reactor provided in (i) further comprises one or more alkali metal and/or alkaline earth metal hydroxides, wherein the one or more alkali metal and/or alkaline earth metal hydroxides are supported on the one or more support materials supporting Ru, wherein the alkali metal and/or alkaline earth metal hydroxides are preferably selected from the group consisting of Mg(OH)₂, Ca(OH)₂, Ba(OH)₂, Sr(OH)₂, LiOH, NaOH, and KOH, including mixtures of two or more thereof, more preferably from the group consisting of Mg(OH)₂, Ca(OH)₂, LiOH, NaOH, and KOH, including mixtures of two or more thereof, more preferably from the group consisting of LiOH, NaOH, and KOH, including mixtures of two or more thereof, wherein more preferably the catalyst further comprises KOH and/or LiOH, preferably KOH.
84. The process of embodiment 83, wherein the NH₃ reforming catalyst C1 contained in the reactor provided in (i) comprises the one or more alkali metal hydroxides in an amount in the range of from 0.5 to 15 wt.-% based on 100 wt.-% of the total amount of the one or more support materials, preferably of from 1 to 10 wt.-%, more preferably of from 2 to 8 wt.-%, more preferably of from 3 to 6.5 wt.-%, more preferably of from 4 to 6 wt.-%, and more preferably of from 4.5 to 5.5 wt.-%.
85. The process of embodiment 83 or 84, wherein from 95 to 100 wt.-% of the NH₃ reforming catalyst C1 contained in the reactor provided in (i) consists of Ru, the one or more alkali metal hydroxides, and the one or more support materials, preferably from 97 to 100 wt.-%, more preferably from 98 to 100 wt.-%, more preferably from 99 to 100 wt.-%, more preferably from 99.5 to 100 wt.-%, and more preferably from 99.9 to 100 wt.-%.
86. The process of any one of embodiments 67 to 85, wherein the NH₃ reforming catalyst C1 contained in the reactor provided in (i) is in the form of a molding and/or in powder form, preferably in the form of a molding, and more preferably in the form of extrudates or tablets.
87. The process of embodiment 86, wherein the extrudates have a diameter in the range of from 0.5 to 10 mm, preferably of from 1 to 7 mm, more preferably of from 1.5 to 5 mm, more preferably of from 2 to 4 mm, and more preferably of from 2.5 to 3.5 mm.
88. The process of embodiment 86 or 87, wherein the extrudates are split, and the NH₃ reforming catalyst C1 contained in the reactor provided in (i) is in the form of extrudates of a split sieve fraction in the range of from 50 μm to 2.5 mm, preferably of from 100 μm to 1.5 mm, more preferably of from 200 μm to 1 mm, more preferably of from 250 to 700 μm, and more preferably of from 300 to 500 μm.
89. The process of embodiment 88, wherein the tablets have a four-hole cross-section, preferably a four-hole cross-section and four flutes.

### DESCRIPTION OF THE FIGURES

FIG. 1: displays the results of NH₃ reforming over a Ni-containing catalyst. The NH₃ conversion is noted in % on the ordinate, and the temperature is noted on the abscissa in ° C. Diamonds (♦) indicate measuring points for the catalyst activated in a H₂ gas atmosphere, and triangles (▴) indicate measuring points for the catalyst activated in an NH₃ gas atmosphere.

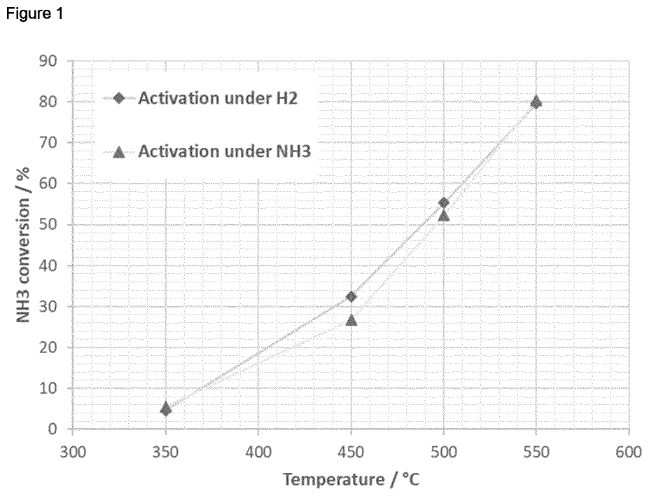

FIG. 2: shows on the left the side view for the arrangement for determining side crushing strength 1 (SCS1), in the middle the side view for the arrangement for determining side crushing strength 2 (SCS2), and on the right the side view for the arrangement for determining side crushing strength 3 (SCS3).

FIG. 3: shows the TPR diagram of the passivated and partially reduced Ni-containing catalyst prepared according to Reference Example 6. On the abscissa, the temperature is noted in ° C., and on the ordinate, the intensity of the TCD signal is noted in arbitrary units.

FIG. 4: shows the TPR diagram fully oxidic Ni-containing catalyst prepared according to Reference Example 7. On the abscissa, the temperature is noted in ° C., and on the ordinate, the intensity of the TCD signal is noted in arbitrary units.

FIG. 5: shows the TPR diagram of the Ni-containing catalyst which was prepared according to Reference Example 6 when analyzed after being used in the testing according to Example 9. On the abscissa, the temperature is noted in ° C., and on the ordinate, the intensity of the TCD signal is noted in arbitrary units.

FIG. 6: shows the TPR diagram of the Ru-containing catalyst prepared according to Reference Example 8. On the abscissa, the temperature is noted in ° C., and on the ordinate, the intensity of the TCD signal is noted in arbitrary units.

### EXPERIMENTAL SECTION

The present invention is further illustrated by the following reference examples, examples and comparative examples.

### Reference Example 1: Determination of Gas Stream Composition by FTIR

A gas stream composition, in particular a H₂O content of a gas stream, was determined using Fourier-transform infrared spectroscopy (FTIR). To this effect, apparatus “IGS Analyzer” from ThermoFisher Scientific was used, whereby software “Omnic 9” was used for data evaluation.

### Reference Example 2: Determination of X-Ray Diffraction (XRD)

Powder X-ray diffraction (PXRD) data was collected using a diffractometer (D8 Advance Series II, Bruker AXS GmbH) equipped with a LYNXEYE detector operated with a Copper anode X-ray tube running at 40 kV and 40 mA. The geometry was Bragg-Brentano, and air scattering was reduced using an air scatter shield.

Computing crystallinity: The crystallinity of the samples was determined using the software DIFFRAC.EVA provided by Bruker AXS GmbH, Karlsruhe, according to the method which is described on page 121 of the user manual. The default parameters for the calculation were used.

Computing phase composition: The phase composition was computed against the raw data using the modelling software DIFFRAC.TOPAS provided by Bruker AXS GmbH (User Manual for DIFFRAC.TOPAS Version 6, 2017, Bruker AXS GmbH, Karlsruhe). The crystal structures of the identified phases, instrumental parameters as well the crystallite size of the individual phases were used to simulate the diffraction pattern. This was fit against the data in addition to a function modelling the background intensities.

For cases, wherein an oxidized or passivated NH₃ reforming catalyst sample was analyzed, the samples were homogenized in a mortar and then pressed into a standard flat sample holder provided by Bruker AXS GmbH for Bragg-Brentano geometry data collection. The flat surface was achieved using a glass plate to compress and flatten the sample powder. The data was collected from the angular range 2 to 70 °2Theta with a step size of 0.02 °2Theta, while the variable divergence slit was set to an angle of 0.1°. The crystalline content describes the intensity of the crystalline signal to the total scattered intensity. The passivated layer results in a rather broad and almost amorphous signal in the XRD. This broad signal is very clearly different to the oxidic moieties of the fresh samples.

For cases, wherein a reduced NH₃ reforming catalyst sample was analyzed, the sample was removed from the reactor under an inert gas atmosphere, and prepared in a glove box under inert gas for XRD analysis using an air tight sample carrier, e. g. an air tight sample holder or a sealed capillary.

### Reference Example 3: Determination of Temperature Programmed Reduction (TPR)

The temperature programmed reduction (TPR) measurement was conducted with a Micromeritics® Autochem II. As reducing gas mixture 5% H₂ in Ar was applied. The hydrogen consumption was monitored via a TCD detector and shown as inverted consumption. Thus, the hydrogen consumption was shown as positive peak. The gas flow was adjusted to 50 ml/min. The hydrogen consumption was further integrated and given in μmol/g (catalyst), related to a certain reduction event.

### Reference Example 4: Determination of the Side Crushing Strength

The side crushing strength was determined on a semi-automatic tablet testing system SotaxST-50 WTDH. The side crushing strength was measured with a constant speed of 0.05 mm/s. A range of from 0 to 800 N could be tested. For each measurement, the orientation of the sample was adjusted with a horizontal rotating table and fine adjustment has been made manually. Further, several measurement parameters were adjusted—if applicable—depending on the orientation and properties of the sample, such as the mass, the height/thickness, the diameter and strength at rupture. The gained data were evaluated with the scientific program q-doc prolab (version 4fsp2 (4.10)). Tablets having a four-hole cross-section were tested, whereby three positions being perpendicular to each other were probed allowing determination of the side crushing strength 1, side crushing strength 2 and side crushing strength 3. The relative standard deviation for crushing strength 1, 2, and 3 was 7.48%.

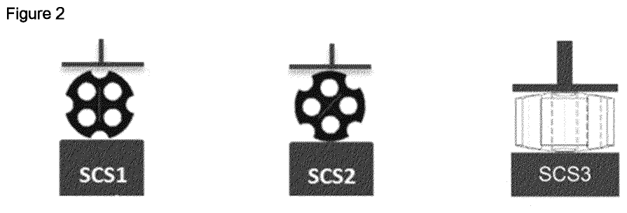

As can be seen in FIG. 2, side crushing strength 1 refers to a position of the tablet in the semi-automatic tablet testing system where the sample stands on two cylindrical segments sided by a flute on the rotating table, side crushing strength 2 refers to a position where the sample stands on one cylindrical segment on the rotating table, and side crushing strength 3 refers to a position where the holes are in parallel to the direction of the force applied on the sample during the test.

### Reference Example 5: Determination of the Side Crushing Strength

The side crushing strength was determined on a tablet testing system (Typ BZ2.5/TS1S, Zwick). The side crushing strength was measured using a punching tool. The side crushing strength was recorded as soon as the sample broke. For each measurement, the orientation of the sample was adjusted manually on a horizontal table. The punching tool was arranged to punch from above. Further, several measurement parameters were adjusted—if applicable—depending on the orientation and properties of the sample, such as the mass, the height/thickness, the diameter and strength at rupture. Tablets having a four-hole cross-section were tested, whereby three positions being perpendicular to each other were probed allowing determination of the side crushing strength 1, side crushing strength 2 and side crushing strength 3. As can be seen in FIG. 2, side crushing strength 1 refers to a position of the tablet in the semi-automatic tablet testing system where the sample stands on two cylindrical segments sided by a flute on the rotating table, side crushing strength 2 refers to a position where the sample stands on one cylindrical segment on the rotating table, and side crushing strength 3 refers to a position where the holes are in parallel to the direction of the force applied on the sample during the test.

### Reference Example 6: Preparation of a Passivated Partially Reduced Ni-Containing Catalyst

A physical mixture of NiO (60 weight-%) and an alumina powder is mixed with water and a binder (e.g. methylcellulose or bentonite) to an extrudable paste. This paste is extruded (⅛″ diameter) and calcined at moderate temperature below 300° C. The obtained catalyst is partially reduced and passivated under air. It was determined according to Reference Example 2, that the partially reduced and passivated catalyst comprised a weight ratio of NiO to elemental Ni of 43:57. The average crystallite size of Ni was 6.0 nm and of NiO 2.5 nm.

The reduction of the passivation layer takes place at mild temperatures of 150-220° C. The residual bulk NiO is reduced at higher temperatures of 400-700° C.

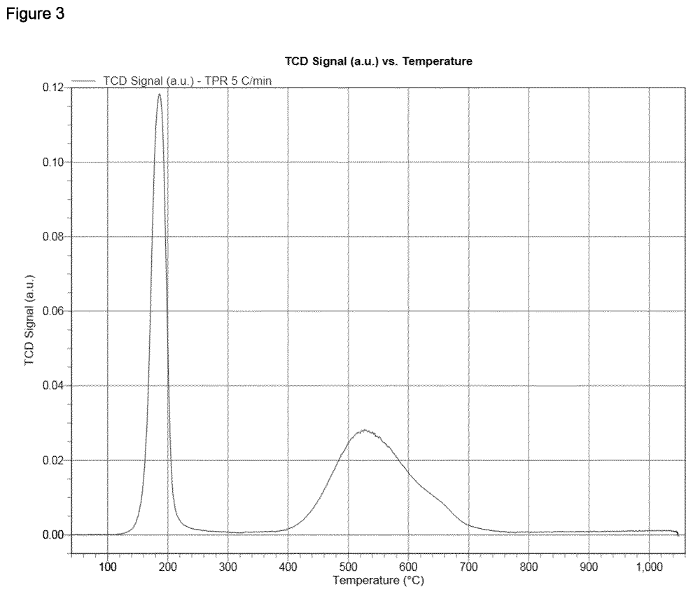

The results of the TPR are shown in Table 1 below, and the TPR diagram is shown in FIG. 3.

TABLE 1
Results of TPR determined according to Reference Example 3.

| | Temperature at maximum | Quantity |
|---|---|---|
| Peak # | [° C.] | [μmol/g] |
| 1 | 186.5 | 2226 |
| 2 | 529.1 | 2690 |

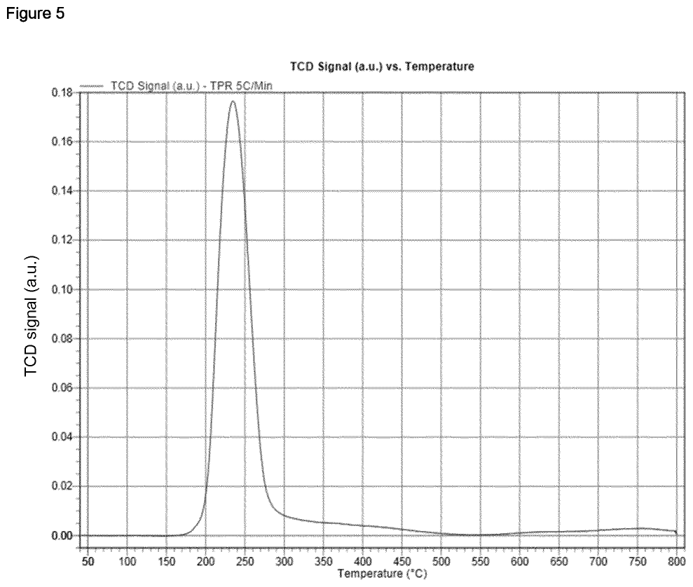

Additionally, the Ni-containing catalyst was analyzed after being used according to the testing according to Example 9. Since the catalyst was not kept under an inert gas atmosphere after being removed from the reactor, partial oxidation in air occurred. The results are shown in FIG. 5 and Table 2 below. Further, it was determined according to Reference Example 2, that the used catalyst comprised a weight ratio of NiO to elemental Ni of 30:70. The average crystallite sizes of Ni was 12 nm and of NiO 2 nm.

TABLE 2
Results of TPR determined according to Reference Example 3.

| | Temperature at maximum | Quantity |
|---|---|---|
| Peak # | [° C.] | [μmol/g] |
| 1 | 235.0 | 2397 |

As it can be gathered from the results shown in FIG. 5 and Table 2 in comparison with that of FIG. 3 and Table 1, the Ni-containing catalyst which was prepared according to Reference Example 6 and then used in the catalytic testing wherein the process of the present invention was applied, shows a strong peak below 400° C. indicating that passivation of metallic Ni occurred when the catalyst was transferred from the reactor to the analytics.

### Reference Example 7: Preparation of a Fully Oxidic Ni-Containing Catalyst

An NH₃-reforming catalyst comprising Ni was prepared following the process described in example E1 of WO 2013/068905 A1.

An aqueous solution of Nickel nitrate (14 weight-% Ni concentration) was mixed with the hydrotalcite and suitable amounts of water to prepare an extrudable paste. This paste was extruded in the next step. The subsequent heat treatments of the resulting extrudates were identical to example 1 (example E1 of WO2013/068905 A1).

The nickel content of the calcined extrudate was 15.5 weight-%, the magnesium content 14.0 weight-%, and the aluminium content was 29.5 weight-%.

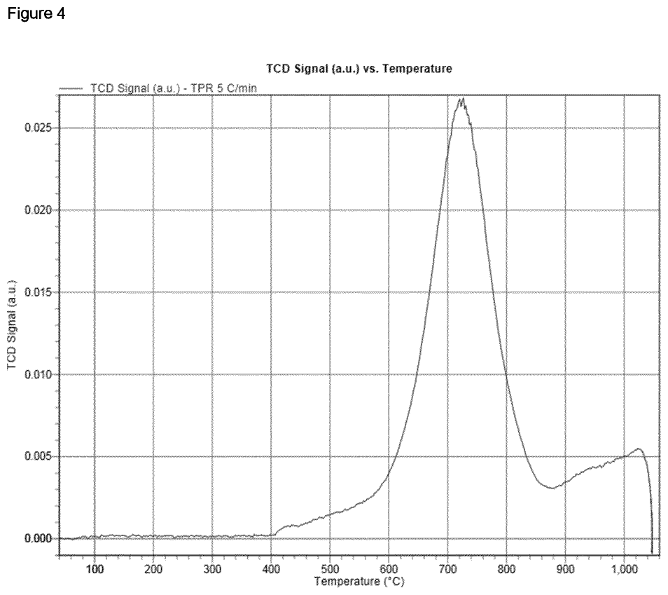

In the TPR determined according to Reference Example 3, it was observed that the first reduction event of the completely oxidic Ni-containing catalyst started at 400° C. and extended to 1000° C. and beyond. The results of the TPR are shown in Table 3 below, and the TPR diagram is shown in FIG. 4.

TABLE 3
Results of TPR determined according to Reference Example 3.

| | Temperature at maximum | Quantity |
|---|---|---|
| Peak # | [° C.] | [μmol/g] |
| 1 | 725.6 | 2110 |
| 2 | 1024.1 | 644 |

### Reference Example 8: Preparation of Ru (5 wt.-%) and KOH (5 wt.-%; Corresponding to 3.5 wt.-% K) Supported on MgAl₂O₄ Spinel

A hydrotalcite precursor (Pural MG30 from Sasol) was calcined at a temperature in the range of from 850 to 980° C. and for a duration in the range of 1 to 3 h, then used as support. 93 g of the support as molding were impregnated with 27 g of Ru(NO)(NO₃)₃ solution (19.7 wt.-% Ru in the solution). After drying at 180° C. for 4 h, the Ru containing moldings were impregnated with 5.105 g of K(OH). The resulting material was then dried at 120° C. for 2 h and then calcined at 500° C. for 2 h under synthetic air consisting of 21 vol.-% O₂ and 79 vol.-% N₂.

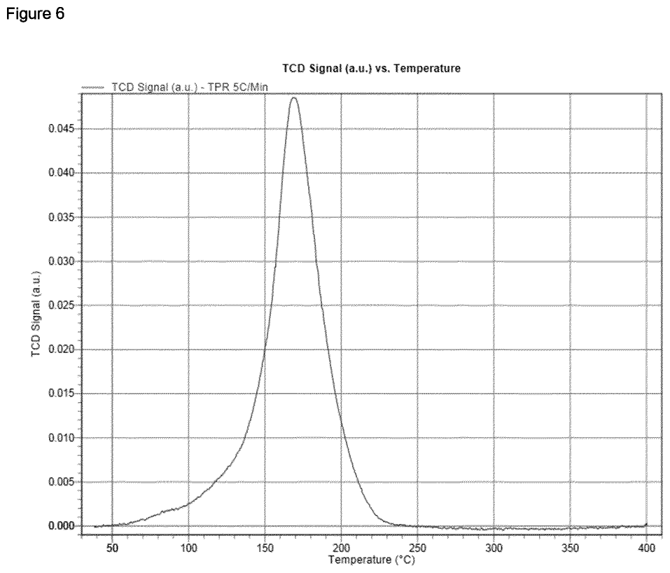

The obtained Ru-containing catalyst was analyzed by TPR according to Reference Example 3. The results are shown in FIG. 6 and Table 4 below.

TABLE 4
Results of TPR determined according to Reference Example 3.

| | Temperature at maximum | Quantity |
|---|---|---|
| Peak # | [° C.] | [μmol/g] |
| 1 | 168.8 | 3277 |

### Example 9: NH₃-Reforming Test

For exemplifying the process of the present invention, a Ni-containing NH₃-reforming catalyst was prepared according to Reference Example 6 in the form of extrudates. Said catalyst was used in an NH₃-reforming process. In one run, the catalyst was activated at a pressure of 20 bara up to temperatures of 400° C. with a heating rate of 2° C./min. At 400° C. the temperature was kept for 1 h. This activation protocol was conducted in a gas stream comprising NH₃ having a partial pressure of 1 bara and being diluted with Ar, before carrying out NH₃ reforming. For comparative reasons, the NH₃-reforming process was conducted in a further run using said catalyst which was conventionally activated in a gas stream comprising 5 volume-% of H₂ in Ar.

For reaching the desired NH₃-reforming conditions, a specific temperature protocol was applied.

NH₃ reforming was then conducted in a gas stream substantially consisting of NH₃ having a gas hourly space velocity (GHSV) of 4000 h⁻¹, wherein NH₃ reforming was performed under a pressure of 40 bara. To a pure NH₃ feed stream, a fraction of 5000 ppm-volume of H₂O was added before feeding into the reactor. The catalysts were tested between 350 and 550° C. The activity of the catalysts activated in different gas atmospheres was determined. The results are shown in Table 5 below.

TABLE 5
NH₃ conversion results of a Ni-based catalyst
activated in different reducing atmospheres.

| | Catalyst activated | Catalyst activated |
|---|---|---|
| Temperature | in H₂ gas stream | in NH₃ gas stream |
| [° C.] | NH₃ conversion | NH₃ conversion |
| 350 | 4.6 | 5.55 |
| 450 | 32.45 | 26.7 |
| 500 | 55.3 | 52.3 |
| 550 | 79.6 | 80.5 |

As it can be gathered from the results for NH₃ reforming, it was found that activating the NH₃ reforming catalysts in a gas stream comprising NH₃ is a suitable method to create a very active catalyst and simplifies the activation and starting sequence of a typical NH₃ reforming process. Thus, it was found that even under elevated pressures, the activation under a gas stream comprising NH₃ is successful and that the NH₃-reforming catalyst shows the same activity level as conventionally activated.

### CITED PRIOR ART

I. Lucentini et al., Ind. Eng. Chem. Res. 2021, 60, 18560-18611
T. Le et al., Korean J. Chem. Eng., 2021, 38(6), 1087-1103
Bell et al., Top Catal., 2016, 59, 1438-1457
X.-K. Li et al., Journal of Catalysis, 2005, 236, 181-189
H. Fang et al., ACS Catalysis 2022, 12, 3938-3954

1.-15. (canceled)

16. A process for activating a catalyst for NH₃ reforming, the process comprising:
(i) providing a reactor containing an NH₃-reforming catalyst C1 comprising a metal M1 selected from the group consisting of groups 6 to 11 of the periodic table, including mixtures of two or more thereof, wherein the X-ray diffractogram of the NH₃-reforming catalyst C1 contained in the reactor provided in (i) displays one or more crystalline phases of one or more oxides of M1 as determined according to Reference Example 2; or wherein the temperature programmed reduction (TPR) profile of the NH₃-reforming catalyst C1 contained in the reactor provided in (i) displays a first peak having a maximum in the range of from 100 to 400° C. as determined according to Reference Example 3,
(ii) preparing a feed gas stream F1 containing NH₃, wherein the feed gas stream F1 comprises from 0.0001 to 0.7 volume-% of H₂O;
(iii) feeding F1 prepared according to (ii) into the reactor and contacting F1 with the NH₃-reforming catalyst C1, wherein the reactor has a temperature of 100° C. or more; obtaining a product gas stream P1 comprising H₂O, and an NH₃-reforming catalyst C2, wherein the X-ray diffractogram of the NH₃-reforming catalyst C2 obtained from (iii) displays one or more crystalline phases of elemental M1 as determined according to Reference Example 2;
wherein feeding according to (ii) is started at a point in time t1;
wherein at a point in time t2 the H₂O(P1):H₂O(F1) molar ratio of H₂O in the product gas stream P1 to H₂O in the feed gas stream F1 is greater than 1:1, wherein the difference between t2 and t1 is in the range of from 5 s to 10 days;
(iv) preparing a feed gas stream F2 comprising NH₃;
(v) feeding the feed gas stream F2 prepared according to (iv) into the reactor and contacting the feed gas stream F2 with the NH₃-reforming catalyst C2 obtained from (iii); and
(vi) removing an effluent gas stream from the reactor, the effluent gas stream comprising H₂ and N₂.

17. The process of claim 16, wherein M1 is selected from the group consisting of Ru, Ni, Rh, Co, Ir, Fe, Pt, Cr, Pd, Cu, and mixtures of two or more thereof.

18. The process of claim 16, wherein the feed gas stream F1 prepared according to (ii) comprises from 0 to 0.5 volume-% of H₂.

19. The process of claim 16, wherein the feed gas stream F1 prepared according to (ii) has an NH₃ partial pressure in the range of from 0.01 to 65 bara.

20. The process of claim 16, wherein the feed gas stream F1 prepared according to (ii) comprises from 0.05 to 0.4 volume-% of H₂O.

21. The process of claim 16, wherein from 99 to 100 volume-% of the feed gas stream F1 prepared according to (ii) consists of NH₃, H₂, H₂O, and optionally an inert gas, wherein the inert gas comprises one or more of Ar and N₂.

22. The process of claim 16, wherein the feed gas stream F1 prepared according to (ii) is fed into the reactor according to (iii) having a gas hourly space velocity in the range of from 100 to 15,000 h⁻¹.

23. The process of claim 16, wherein contacting according to (iii) is performed at a pressure in the range of from 1 to 65 bara.

24. The process of claim 16, wherein contacting according to (iii) is performed at a temperature in the range of from 200 to 1000° C.

25. The process of claim 16, wherein the feed gas stream F2 prepared according to (iv) comprises from 1 to 100 volume-% of NH₃.

26. The process of claim 16, wherein from 99 to 100 volume-% of the feed gas stream F2 prepared according to (iv) consists of NH₃, H₂, optionally H₂O, and optionally an inert gas, wherein the inert gas comprises one or more of Ar and N₂.
